(19) United States
(12) Patent Application Publication
(10) Pub. No.: US 2008/0051190 A1
(43) Pub. Date: Feb. 28, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/783,587

(22) Filed: Apr. 10, 2007

Related U.S. Application Data
(60) Provisional application No. 60/840,004, filed on Aug. 25, 2006.

(51) Int. Cl. A63F 9/24; G07F 17/34

(52) U.S. Cl. 463/21

(57) ABSTRACT

A player designates one of symbols repositioned in respective symbol display regions within a first symbol display frame with the aid of a touch panel. The player further designates one of spinning-state symbol display regions within a second symbol display frame with the aid of the touch panel. Consequently, the symbol in the symbol display region designated by the player within the first symbol display frame is repositioned in the symbol display region designated by the player within the second symbol display frame by drag operation.

### CROSS-REFERENCE TO THE RELATED APPLICATION(S)

This application is based upon and claims a priority from the U.S. provisional Patent Application No. 60/840,004 filed on Aug. 25, 2006, the entire contents thereof are incorporated herein by reference.

### BACKGROUND OF THE INVENTION

1. Field of the Invention

The present invention relates to a slot machine and playing method thereof in which a payout is awarded depending on a symbol combination consisting of repositioned symbols.

2. Description of Related Art

In conventional slot machines, a combination of symbols amongst plural symbols repositioned in a matrix is defined by symbols positioned on a pay line, and in case a symbol combination on the pay line coincides with a winning symbol combination, a payout associated with the winning symbol combination is awarded.

In this regard, a pay line generally passes through all of the columns in a matrix.

U.S. Pat. No. 6,604,999B2 and US Patent Application Publication No. 2002/0065124A1 disclose a gaming machine in which a special pay line which passes through fewer than all of the columns in a matrix is provided so as to enhance player's interest to games.

### SUMMARY OF THE INVENTION

The object of the present invention is to provide a slot machine and playing method thereof which has new entertaining factors which conventional ones did not have inherently.

Therefore, in order to achieve the object, according to a first aspect of the present invention, there is provided a slot machine comprising: a symbol display frame for displaying plural symbols individually positioned; a display for displaying the symbol display frame; a touch panel for enabling a player to designate one of locations within the symbol display frame or one of plural symbols individually displayed within the symbol display frame; and a game controller programmed to operate with the display (a) to reposition plural symbols individually positioned within the symbol display frame and newly display plural symbols individually repositioned within the symbol display frame every game, and (b) in case the player designated a symbol among plural symbols displayed within the symbol display frame in a preceding game with the touch panel when the game controller carries out the operation (a), to newly reposition and display a designated symbol within the symbol display frame during a current game in a manner that the player drags the designated symbol to a location the player designates with the touch panel within the symbol display frame during the current game.

Furthermore, according to a second aspect of the present invention, there is provided a slot machine comprising: a symbol display frame for displaying plural symbols individually positioned; a display for displaying the symbol display frame; a touch panel for enabling a player to designate one of locations within the symbol display frame or one of plural symbols individually displayed within the symbol display frame; and a game controller programmed to operate with the display (a) to reposition plural symbols individually positioned within the symbol display frame and newly display plural symbols individually repositioned within the symbol display frame every game, and (b) when the game controller carries out the operation (a), (1) to determine number of symbols the player can designate among plural symbols displayed within the symbol display frame in the preceding game with the touch panel, after end of the preceding game and no later than start of the current game, (2) in case the player designated a symbol among plural symbols displayed within the symbol display frame in the preceding game with the touch panel within a number range determined by the operation (1), to newly reposition and display a designated symbol within the symbol display frame during the current game in a manner that the player drags the designated symbol to a location the player designates with the touch panel within the symbol display frame during the current game, and (3) for carrying out the operation (2), to restrict locations within the symbol display frame the player can designate with the touch panel during the current game to locations within the symbol display frame where repositioning of symbols are being carried out.

Furthermore, according to a third aspect of the present invention, there is provided a slot machine comprising: a symbol display frame for displaying plural symbols individually positioned; a display for displaying the symbol display frame; a touch panel for enabling a player to designate one of locations within the symbol display frame or one of plural symbols individually displayed within the symbol display frame; and a game controller programmed to operate with the display (a) to reposition plural symbols individually positioned within the symbol display frame and newly display plural symbols individually repositioned within the symbol display frame every game, and (b) when the game controller carries out the operation (a), (1) to display number of symbols the player can designate among plural symbols repositioned within the symbol display frame in the preceding game with the touch panel, after end of the preceding game and no later than start of the current game, (2) in case the player designated a symbol among plural symbols displayed within the symbol display frame in the preceding game with the touch panel within a number range displayed by the operation (1), to newly reposition and display a designated symbol within the symbol display frame during the current game in a manner that the player drags the designated symbol to a location the player designates with the touch panel within the symbol display frame during the current game, and (3) for carrying out the operation (2), to restrict locations within the symbol display frame the player can designate with the touch panel during the current game to locations within the symbol display frame where repositioning of symbols are being carried out.

Furthermore, according to a fourth aspect of the present invention, there is provided a slot machine comprising: a symbol display frame for displaying plural symbols individually positioned; a display for displaying the symbol display frame; a touch panel for enabling a player to designate one of locations within the symbol display frame or one of plural symbols individually displayed within the symbol display frame; and a game controller programmed to operate with the display (a) to reposition plural symbols individually positioned within the symbol display frame and newly display plural symbols individually repositioned within the symbol display frame every game, and (b) when the game controller carries out the operation (a), (1) to determine and display, number of symbols the player can designate among plural symbols repositioned within the symbol display frame in the preceding game with the touch panel, after end of the preceding game and no later than start of the current game, (2) in case the player designated a symbol among plural symbols displayed within the symbol display frame in the preceding game with the touch panel within a number range determined by the operation (1), to newly reposition and display a designated symbol within the symbol display frame during the current game in a manner that the player drags the designated symbol to a location the player designates with the touch panel within the symbol display frame during the current game, and (3) for carrying out the operation (2), to restrict locations within the symbol display frame the player can designate with the touch panel during the current game to locations within the symbol display frame where repositioning of symbols are being carried out.

Furthermore, according to a fifth aspect of the present invention, there is provided a slot machine comprising: plural symbol display regions for individually displaying plural symbols positioned; a symbol display frame constituted by arranging the plural symbol display regions in a matrix form; a display for displaying the symbol display frame; a touch panel for enabling a player to designate one of plural symbol display regions or one of the plural symbols individually displayed in the plural symbol display regions; a spin button for enabling the player to give a chance to start a game; and a game controller programmed to operate with the display (a) to reposition plural symbols individually positioned in the plural symbol display regions and newly display plural symbols individually repositioned in the plural symbol display regions by scrolling the plural symbol display regions in response to a chance to start a game given by the player, (b) when the game controller carries out the operation (a), (1) to determine number of symbols the player can designate among plural symbols individually displayed in the plural symbol display regions, which results from scroll of the plural symbol display regions in the preceding game, with the touch panel, after end of the preceding game and no later than start of the current game starts, (2) when the player presses the spin button to give a change to start the current game, to cause the display to display a new symbol display frame structurally same as the symbol display frame so as to use in the current game, (3) to make plural symbol display regions of the new symbol display frame scroll for the current game, (4) when the player designates one of plural symbols individually displayed in the plural display regions in the symbol display frame used in the preceding game with the touch panel and further designates one of plural symbol display regions in the new symbol display frame with the touch panel, to reposition a designated symbol in a designated symbol display region within a number range determined by the operation (1) in a manner that the player drags the designated symbol to the designated symbol display region with the touch panel during the current game, and (5) for carrying out the operation (4), to restrict symbol display regions the player can designate with the touch panel within the new symbol display frame to symbol display regions where scrolling of symbols are being carried out for the current game.

Furthermore, according to a sixth aspect of the present invention, there is provided a slot machine comprising: plural symbol display regions for individually displaying plural symbols positioned; a symbol display frame constituted by arranging the plural symbol display regions in a matrix form; a display for displaying the symbol display frame; a touch panel for enabling a player to designate one of plural symbol display regions or one of the plural symbols individually displayed in the plural symbol display regions; a spin button for enabling the player to give a chance to start a game; and a game controller programmed to operate with the display (a) to reposition plural symbols individually positioned in the plural symbol display regions and newly display plural symbols individually repositioned in the plural symbol display regions by scrolling the plural symbol display regions in response to a chance to start a game given by the player, (b) when the game controller carries out the operation (a), (1) to display number of symbols the player can designate among plural symbols individually displayed in the plural symbol display regions, which results from scroll of the plural symbol display regions in the preceding game, with the touch panel, after end of the preceding game and no later than start of the current game starts, (2) when the player presses the spin button to give a change to start the current game, to make the plural symbol display regions which individually display plural symbols of the preceding game start scrolling sequentially by taking time difference for the current game, (3) when the player designates one of plural symbols individually displayed in the plural symbol display regions in the preceding game with the touch panel before start of scrolling symbols for the current game, to make a symbol display region directed to a designated symbol start scrolling, (4) when the player designates one of the plural symbol display regions in the symbol display frame with the touch panel, to reposition and display a symbol designated by the operation (3) in the designated symbol display region by dragging within a number range displayed by the operation (1) during the current game, and (5) for carrying out the operation (4), to restrict symbol display regions the player can designate with the touch panel to symbol display regions where scrolling of symbols are being carried out for the current game.

Furthermore, according to a seventh aspect of the present invention, there is provided a slot machine comprising: plural symbol display regions for individually displaying plural symbols positioned; a symbol display frame constituted by arranging the plural symbol display regions in a matrix form; a display for displaying the symbol display frame; a touch panel for enabling a player to designate one of plural symbol display regions or one of the plural symbols individually displayed in the plural symbol display regions; a spin button for enabling the player to give a chance to start a game; and a game controller programmed to operate with the display (a) to reposition plural symbols individually positioned in the plural symbol display regions and newly display plural symbols individually repositioned in the plural symbol display regions by scrolling the plural symbol display regions in response to a chance to start a game given by the player, (b) when the game controller carries out the operation (a), (1) to display number of symbols the player can designate among plural symbols individually displayed in the plural symbol display regions, which results from scroll of the plural symbol display regions in the preceding game, with the touch panel, after end of the preceding game and no later than start of the current game starts, (2) when the player presses the spin button to give a change to start the current game after the player has designated one of plural symbols individually displayed in the plural symbol display regions in the preceding game with touch panel, to make the plural symbol display regions which individually displayed plural symbols of the preceding game start scrolling for the current game, (3) when the player designates one of the plural symbol display regions in the symbol display frame with the touch panel, to reposition and display a symbol designated by the operation (2) in the designated symbol display region by dragging within a number range displayed by the operation (1) during the current game, and (4) for carrying out the operation (3), to restrict symbol display regions the player can designate with the touch panel to symbol display regions where scrolling of symbols are being carried out for the current game.

Furthermore, according to an eighth aspect of the present invention, there is provided a playing method of a slot machine in which game controller repeats a game by using a display which displays a symbol display frame in which plural symbols are positioned, the playing method comprising: a step of causing the display to reposition and newly display plural symbols individually within the symbol display frame every game with the game controller, the step comprising the sub-steps of (1) making a player designate one of plural symbols displayed within the symbol display frame in a preceding game with a touch panel, (2) making the player designate one of plural locations within the symbol display frame in a current game with the touch panel, and (3) causing the display to newly reposition and display a symbol designated at the sub-step (1) in a location within the symbol display frame designated at the sub-step (2) by dragging during the current game with the game controller.

Furthermore, according to a ninth aspect of the present invention, there is provided a playing method of a slot machine in which game controller repeats a game by using a display which displays a symbol display frame in which plural symbols are positioned, the playing method comprising: a step of causing the display to reposition and newly display plural symbols individually within the symbol display frame every game with the game controller, the step comprising the sub-steps of, (1) determining number of symbols the player can designate among plural symbols displayed within the symbol display frame in a preceding game with the touch panel, after end of the preceding game and no later than start of a current game, (2) making the player designate a symbol among plural symbols displayed within the symbol display frame in the preceding game with the touch panel within a number range determined at the sub-step (1), (3) restricting locations within the symbol display frame the player can designate with the touch panel during the current game to locations within the symbol display frame where repositioning of symbols are being carried out with the game controller, (4) making the player designate a location among can-be-designated locations restricted at the sub-step (3) within the symbol display frame with the touch panel, and (5) repositioning a symbol designated at the sub-step (2) to a location within the symbol display frame designated at the sub-step (4) by dragging during the current game.

Furthermore, according to a tenth aspect of the present invention, there is provided a playing method of a slot machine in which game controller repeats a game by using a display which displays a symbol display frame in which plural symbols are positioned, the playing method comprising: a step of causing the display to reposition and newly display plural symbols individually within the symbol display frame every game with the game controller, the step comprising the sub-steps of, (1) displaying number of symbols the player can designate among plural symbols displayed within the symbol display frame in a preceding game with the touch panel, after end of the preceding game and no later than start of a current game, (2) making the player designate a symbol among plural symbols displayed within the symbol display frame in the preceding game with the touch panel within a number range displayed at the sub-step (1), (3) restricting locations within the symbol display frame the player can designate with the touch panel during the current game to locations within the symbol display frame where repositioning of symbols are being carried out with the game controller, (4) making the player designate a location among can-be-designated locations restricted at the sub-step (3) within the symbol display frame with the touch panel, and (5) repositioning a symbol designated at the sub-step (2) to a location within the symbol display frame designated at the sub-step (4) by dragging during the current game.

Furthermore, according to an eleventh aspect of the present invention, there is provided a playing method of a slot machine in which game controller repeats a game by using a display which displays a symbol display frame in which plural symbols are positioned, the playing method comprising: a step of causing the display to reposition and newly display plural symbols individually within the symbol display frame every game with the game controller, the step comprising the sub-steps of, (b 1) determining with the game controller and causing the display to display number of symbols the player can designate among plural symbols displayed within the symbol display frame in a preceding game with the touch panel, after end of the preceding game and no later than start of a current game, (2) making the player designate a symbol among plural symbols displayed within the symbol display frame in the preceding game with the touch panel within a number range determined at the sub-step (1), (3) restricting locations within the symbol display frame the player can designate with the touch panel during the current game to locations within the symbol display frame where repositioning of symbols are being carried out with the game controller, (4) making the player designate a location among can-be-designated locations restricted at the sub-step (3) within the symbol display frame with the touch panel, and (5) repositioning a symbol designated at the sub-step (2) to a location within the symbol display frame designated at the sub-step (4) by dragging during the current game.

Furthermore, according to a twelfth aspect of the present invention, there is provided a playing method of a slot machine in which game controller repeats a game by using a display which displays a symbol display frame consisting of plural symbol display regions for individually displaying plural symbols arranged in a matrix form, the playing method comprising: a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of, (1) determining number of symbols the player can designate among plural symbols individually displayed in the plural symbol display regions, which results from scroll of the plural symbol display regions in a preceding game, with the touch panel, after end of the preceding game and no later than start of a current game starts, (2) making a player give a chance to start a game with the spin button, (3) causing the display to display a new symbol display frame structurally same as the symbol display frame so as to use in the current game in the display with the game controller, (4) making plural symbol display regions of the new symbol display frame scroll for the current game with the game controller, (5) making the player designate one of plural symbols individually displayed in the plural symbol display regions within the symbol display frame used in the preceding game with the touch panel, (6) restricting symbol display regions the player can designate with the touch panel within the new symbol display frame to symbol display regions where scrolling of symbols are being carried out for the current game with the game controller, (7) making the player designate a symbol display region among can-be-designated symbol display regions restricted at the sub-step (6) within the new symbol display frame with the touch panel, and (8) repositioning a symbol designated at the sub-step (5) in a symbol display region designated at the sub-step (7) by dragging within a number range determined at the sub-step (1) with the game controller.

Furthermore, according to a thirteenth aspect of the present invention, there is provided a playing method of a slot machine in which game controller repeats a game by using a display which displays a symbol display frame consisting of plural symbol display regions for individually displaying plural symbols arranged in a matrix form, the playing method comprising: a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of, (1) causing the display to display number of symbols the player can designate among plural symbols individually displayed in the plural symbol display regions, which results from scroll of the plural symbol display regions in a preceding game, with the touch panel, after end of the preceding game and no later than start of a current game starts with the game controller, (2) making a player give a chance to start a game with the spin button, (3) making the plural symbol display regions which individually display plural symbols of the preceding game start scrolling sequentially by taking time difference for the current game with the game controller, (4) making the player designate one of plural symbols individually displayed in the plural symbol display regions with game controller, which results from scroll of the plural symbol display regions in the preceding game, before scrolling of symbols is started for the current game, (5) making at least one symbol display region including a symbol display region directed to a symbol designated at the sub-step (4) start scrolling for the current game with the game controller, (6) restricting symbol display regions the player can designate with the touch panel to symbol display regions where scrolling symbols are being carried out for the current game with the game controller, (7) making the player designate a symbol display region among can-be-designated symbol display regions restricted at the sub-step (6) with the touch panel, and (8) repositioning a symbol designated at the sub-step (4) in a symbol display region designated at the sub-step (7) by dragging within a number range determined at the sub-step (1) with the game controller.

Furthermore, according to a fourteenth aspect of the present invention, there is provided a playing method of a slot machine in which game controller repeats a game by using a display which displays a symbol display frame consisting of plural symbol display regions for individually displaying plural symbols arranged in a matrix form, the playing method comprising: a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of, (1) causing the display to display number of symbols the player can designate among plural symbols individually displayed in the plural symbol display regions, which results from scroll of the plural symbol display regions in a preceding game, with the touch panel, after end of the preceding game and no later than start of a current game starts with the game controller, (2) making the player designate one of plural symbols individually displayed in the plural symbol display regions with game controller, which results from scroll of the plural symbol display regions in the preceding game, before scrolling of symbols is started for the current game, (3) making a player give a chance to start a game with the spin button, (4) making the plural symbol display regions which individually display plural symbols of the preceding game start scrolling for the current game with the game controller, (5) restricting symbol display regions the player can designate with the touch panel to symbol display regions where scrolling symbols are being carried out for, the current game with the game controller, (6) making the player designate a symbol display region among can-be-designated symbol display regions restricted at the sub-step (5) with the touch panel, (7) repositioning a symbol designated at the sub-step (2) in a symbol display region designated at the sub-step (6) by dragging within a number range determined at the sub-step (1) with the game controller.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a diagram for illustrating a feature of typical game developments of a slot machine directed to a first embodiment that may be encountered in accordance with the principles of the present invention;

FIG. 2 is a perspective view showing an outline construction of the slot machine;

FIG. 3 is an exemplary block diagram showing a control system of the slot machine;

FIG. 4 is a first payout table showing winning symbol combinations and payouts associated with the respective winging symbol combinations applied during a base game;

FIG. 5 is a second payout table showing winning symbol combinations and payouts associated with the respective winging symbol combinations applied during a base game;

FIG. 6 is a diagram depicting what is displayed in a lower-side image display panel;

FIG. 7 is a diagram depicting what is displayed in the lower-side image display panel;

FIG. 8 is a diagram depicting what is displayed in the lower-side image display panel;

FIG. 9 is a diagram depicting what is displayed in the lower-side image display panel;

FIG. 10 is a flowchart of a main control program;

FIG. 11 is a flowchart of a main game processing program;

FIG. 12 is a flowchart of a symbol display control processing program;

FIG. 13 is a diagram depicting what is displayed in a lower-side image display panel of a slot machine directed to a second embodiment;

FIG. 14 is a diagram depicting what is displayed in the lower-side image display panel of the slot machine;

FIG. 15 is a diagram for illustrating how each reel in the lower-side display virtually starts spinning;

FIG. 16 is a diagram for illustrating a feature of typical game developments of a slot machine directed to a second embodiment that may be encountered in accordance with the principles of the present invention;

FIG. 17 is a diagram depicting what is displayed in the lower-side image display panel of the slot machine;

FIG. 18 is flowchart of a main game processing of the slot machine;

FIG. 19 is a flowchart of a symbol display control processing program of the slot machine;

FIG. 20 is a diagram for illustrating a feature of typical game developments of a slot machine directed to a third embodiment that may be encountered in accordance with the principles of the present invention;

FIG. 21 is a flowchart of a main game processing of the slot machine;

FIG. 22 is a flowchart of a drag preparation processing program of the slot machine; and

FIG. 23 is a flowchart of a symbol display control processing program of the slot machine.

### DETAILED DESCRIPTION OF THE PREFERRED EMBODIMENTS

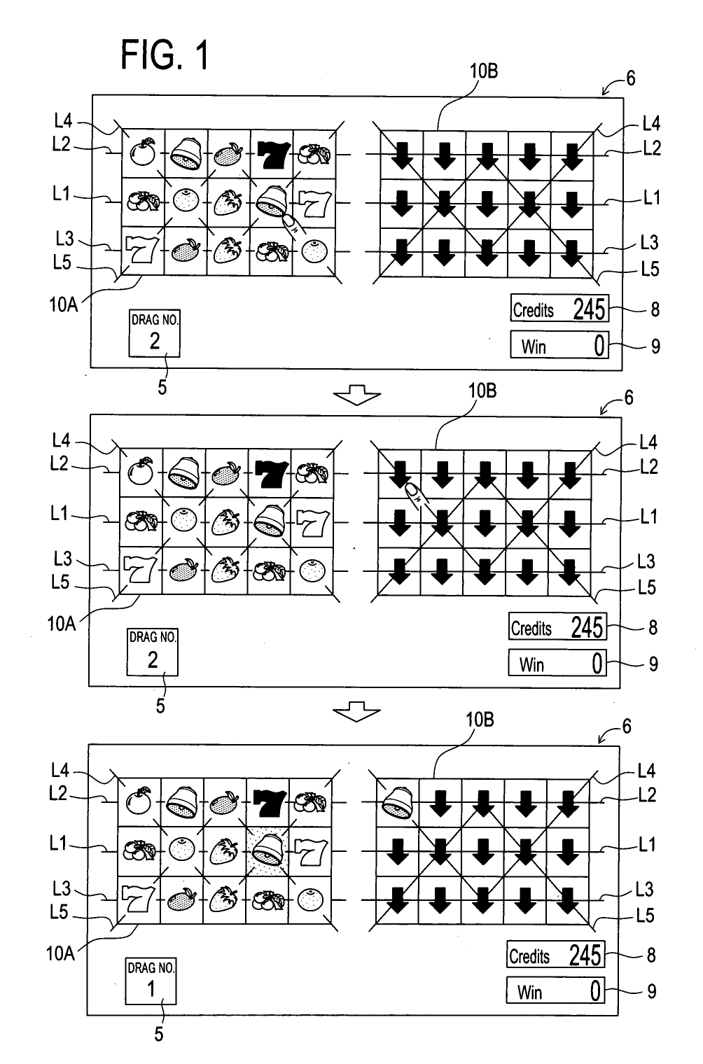

FIG. 1 is a diagram for illustrating a feature of typical game developments of a slot machine directed to a first embodiment that may be encountered in accordance with the principles of the present invention. In the slot machine directed to the first embodiment, as shown in FIG. 1, a lower-side image display panel 6 is a video display and displays a first symbol display frame 10A in which fifteen symbols in total are positioned in a form of 3 rows×5 columns matrix. More specifically, in the first symbol display frame 10A, there are arranged fifteen symbol display regions in a form of 3 rows×5 columns matrix and in each of the fifteen symbol display regions, a single symbol out of plural symbols depicted on a single reel band is positioned. That is, a single symbol display region is assigned to each of the fifteen reels. Furthermore, on the first symbol display frame 10A displayed in the lower-side image display panel 6, there are formed five pay lines L1, L2, L3, L4, and L5. Furthermore, a credit amount display section 8 and a payout amount display section 9 are provided at the lower part of the lower-side image display panel 6. There have previously been determined various winning symbol combinations.

In every base game carried out by the slot machine of the first embodiment, spin buttons are operated by a player, whereby some or all of the five pay lines L1, L2, L3, L4, and L5 is/are activated depending on the number of bets. Consequently, a second symbol display frame 10B independent of the fist symbol display frame 10A is newly displayed beside the first symbol display frame 10A in the lower-side image display panel 6. Similar to the first symbol display frame 10A, in the second symbol display frame 10B, fifteen symbol display regions are arranged in a form of 3 rows×5 columns matrix and pay lines L1, L2, L3, L4, and L5 are formed thereon concurrently. After that, each of the reels virtually spins and stops in each of the symbol display regions within the second symbol display frame 10B, whereby a single symbol is repositioned in each of the symbol display regions. In case a combination of five symbols repositioned on an activated pay line L within the second symbol display frame 10B coincides with a certain winning symbol combination, a payout for the winning symbol combination is awarded to a player.

In case plural “ORANGE” symbols, defined as scatter symbol in the embodiment, are repositioned in some of the symbol display regions within the second symbol display frame 10B, a payout for a combination of “ORANGE” symbols and any symbol(s) (termed as “scatter-and-any combination payout” hereinafter) is awarded to a player depending on the number of “ORANGE” symbols on condition that three, four, or five “ORANGE” symbols are repositioned in the second symbol display frame 10B regardless whether or not the scatter symbols are repositioned on one of the pay line L1, L2, L3, L4, and L5.

The second symbol display frame 10B with fifteen symbols repositioned is overwritten on the first display frame 10A with preceding fifteen symbols positioned and displayed thereon in place of the first display frame 10A, and after that, it is erased out from the lower-side image display panel 6. That is, the fifteen symbols repositioned in the second symbol display frame 10B in a preceding game are transferred and repositioned in the first symbol display frame 10A by the time a next game begins.

In case a player carries out the following operation in a next game, a certain symbol positioned in the first symbol display frame 10A can be repositioned in the second symbol display frame 10B by drag operation. That is, one of fifteen symbols repositioned in respective fifteen symbol display regions in a preceding game can be repositioned on one of the fifteen symbol display regions in a next game. For such operation, a player shall touch one of symbols positioned in respective symbol display regions within the first symbol display frame 10A after respective reels in respective symbol display regions within the second symbol display region 10B start spinning virtually, as shown at an upper stage of FIG. 1. Further on, as shown at a middle stage of FIG. 1, the player shall touch one of the symbol display regions of which reels are spinning within the second symbol display frame 10B. Consequently, as shown at a lower stage of FIG. 1, the symbol the player touched in the first symbol display frame 10A is dragged to the symbol display region of the second symbol display frame 10B the player touched and finally repositioned thereon.

It is to be noted that a symbol drag destination is restricted to one of symbol display regions the player touched while corresponding reels were virtually spinning. Accordingly, a symbol display region of which corresponding reel stops spinning within the second symbol display frame 10B cannot be a symbol drag destination.

Furthermore, the number of symbols a player can drag is restricted to a number indicated in a drag number frame 5. The number to drag is determined by a lottery which is carried out before the player operates spin buttons.

The embodiment of the present invention will be described in detail by referring to the drawings.

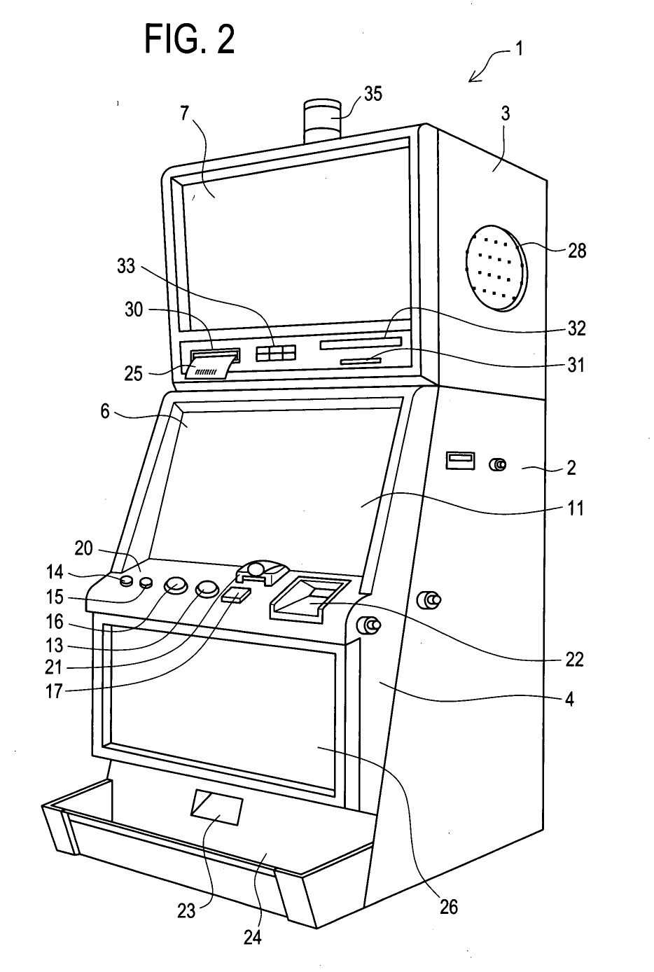

Firstly, schematic structure of a slot machine 1 directed to the first embodiment will be described by referring to FIG. 2. FIG. 2 is a perspective view showing an outline construction of the slot machine 1 directed to the first embodiment.

The slot machine 1 directed to the first embodiment includes: a cabinet 2; a top box 3 arranged above of the cabinet 2; and a main door 4 provided on a front face of the cabinet 2.

An upper-side image display panel 7 is provided on a front face of the top box 3. The upper-side image display panel 7 is structured with a well-known crystal liquid panel which usually displays demonstration animation, information about the slot machine such as game rules, payout table, and the like.

A lower-side image display panel 6 is provided on the main door 4.

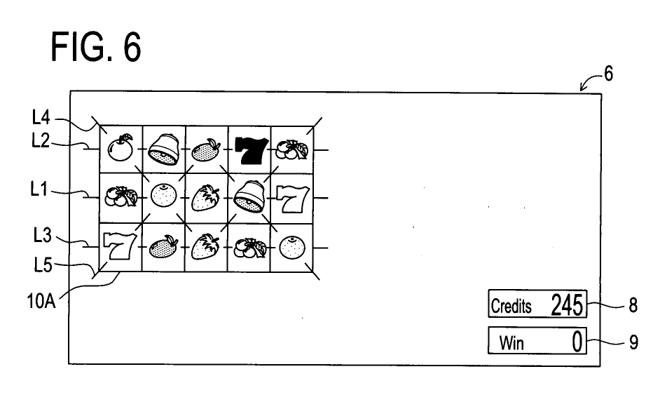

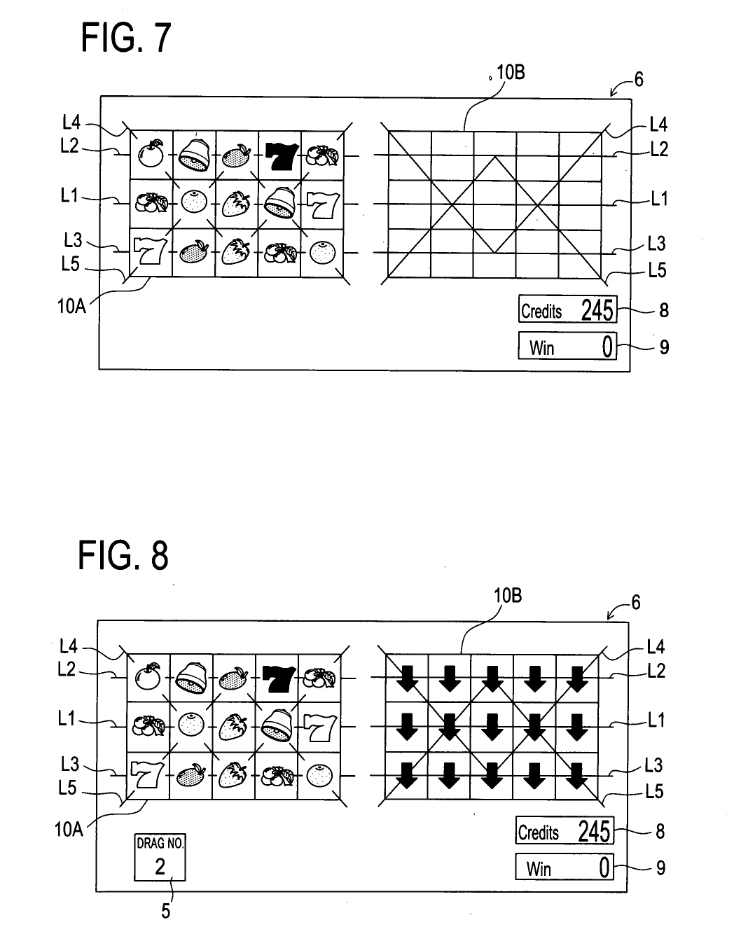

Here will be described game-related images to be displayed in the lower-side image display panel 6 of the slot machine 1. As examples of game-related images, FIG. 6 through FIG. 9 depict what are displayed in the lower-side image display panel 6. During stand-by state in a base game, as shown in FIG. 7, there is displayed a first symbol display frame 10A in which fifteen symbols are positioned in a form of 3 rows×5 columns matrix. More specifically, in the first symbol display frame 10A, there are arranged fifteen symbol display regions in a form of 3 rows×5 columns matrix and in each of the fifteen symbol display regions, a single symbol out of plural symbols depicted on a single reel band is positioned. That is, a single symbol display region is assigned to each of the fifteen reels. In each of the symbol display regions, there is positioned a single symbol out of plural symbols depicted on a reel band.

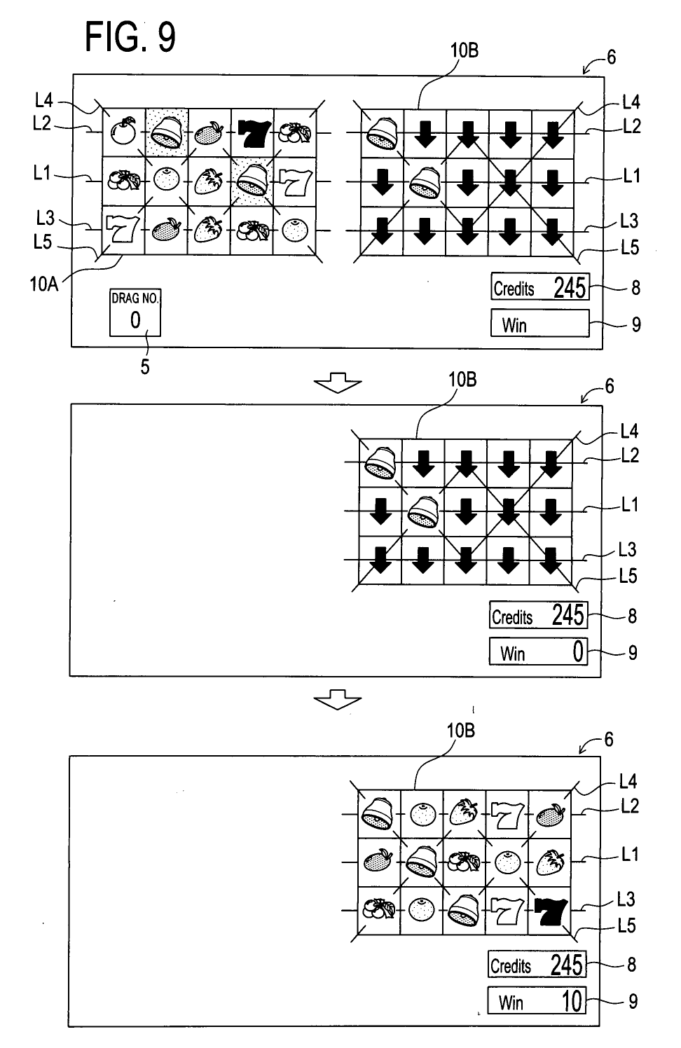

As shown in FIG. 7, a second symbol display frame 10B independent of the fist symbol display frame 10A is newly displayed beside the first symbol display frame 10A. Similar to the first symbol display frame 10A, in the second symbol display frame 10B, fifteen symbol display regions are arranged in a form of 3 rows×5 columns matrix. After that, as shown in FIG. 8, in a base game, each of the reels virtually spins and stops in each of the symbol display regions within the second symbol display frame 10B. Then, as shown at a lower stage of FIG. 9, reels in respective symbol display regions within the second symbol display frame 10B stop spinning, whereby symbols depicted on respective reel bands are repositioned.

It is to be noted that a symbol column consisting of twenty-two symbols is depicted on each reel band.

Furthermore, a touch panel 11 (see FIG. 2) is provided on a front face of the lower-side image display panel 6, whereby a player can input various instructions to designate a symbol and a symbol display region, and the like with the touch panel 11 For example, a player touches to designate a “BELL” symbol in the first symbol display frame 10A with the touch panel 11 (see FIG. 2) and subsequently touches and designate any one of symbol display regions of which reels are spinning in the second symbol display frame 10B with the touch panel 11, whereby the designated “BELL” symbol can be repositioned on the designated symbol display region by drag operation. The upper and middle stages of FIG. 9 illustrates a case that two “BELL” symbols in the first symbol display frame 10A are repositioned on two of symbol display regions in the second symbol display frame 10B by drag operation.

It is to be noted that the number of symbols a player can drag is restricted to a number indicated in the drag number frame 5. The number indicated in the drag number frame 5 means remaining number of symbols the player currently can drag. When the number indicated in the drag number frame 5 reaches “0” as shown at the upper stage of FIG. 9, the drag number frame 5 and the first symbol display frame 10A are erased out from the lower-side image display panel 6 as shown at the middle stage of FIG. 9.

Furthermore, a credit amount display section 8 and a payout amount display section 9 are provided in the lower-side image display panel 6. The credit amount display section 8 displays amount of credits the player currently holds. The payout amount display section 9 displays: amount of payout to be awarded in case a symbol combination repositioned on an activated pay line L within the second symbol display frame 10B coincides with a certain winning symbol combination; amount of payout to be awarded in case a scatter-and-any combination is repositioned within the second symbol display frame 10B; and amount of payouts won by a bonus game.

That is, in the lower-side image display panel 6, there is displayed the first symbol display frame 10 A with fifteen symbol display regions arranged in a form of 3 rows×5 columns matrix, and a single symbol is displayed in each of the fifteen symbol display regions. Furthermore, in the lower-side image display panel 6, there is also displayed the second symbol display frame 10B with fifteen symbol display regions arranged in a form of 3 rows×5 columns matrix. Still further, as shown in FIG. 6 through FIG. 9, there are formed five pay lines L1, L2, L3, L4, and L5 each of which passes through the first symbol display frame 10A and there are formed another five pay lines L1, L2, L3, L4, and L5 each of which passes through the second symbol display frame 10B. Each of the pay lines L1, L2, L3, L4, and L5 is to define a combination of five symbols thereon. In the second symbol display frame 10B, a single symbol depicted on each reel band is repositioned in each symbol display region. In case a combination of symbols repositioned on an activated pay line L of the second symbol display frame 10B coincide with a winning symbol combination, a payout of the winning symbol combination is awarded to a player. After that, the second symbol display frame 10B with fifteen symbols repositioned is overwritten on the first display frame 10A with preceding fifteen symbols positioned and displayed thereon in place of the first display frame 10A. After that, the second display frame 10B is erased out from the lower-side image display panel 6 (see the lower stage of FIG. 9, and FIG. 6).

It is to be noted that, during a bonus game, predetermined bonus game images are displayed together with the credit amount display section 8 and the payout amount display section 9 in a state that images of the symbol display frames 10A and 10B (including each of the reels) and the pay lines L1, L2, L3, L4, and L5 are erased out.

Back to FIG. 2, below the lower-side image display panel 6, there are provided a control panel 20 which consists of plural buttons with which a player inputs instructions concerning game progress, a coin insertion slot 21 for accepting coins, gaming media, in the cabinet 2, and a bill validator 22.

The control panel 20 includes a spin button 13, a change button 14, a CASHOUT button 15, a 1-BET button 16 and a MAX-BET button 17. The spin button 13 is operation means for inputting an instruction to display the second symbol display frame 10B and to let each of the reels start spinning within the second display frame 10B. The change button 14 is operation means for asking a shop keeper of money changing. The CASHOUT button 15 is operation means for inputting an instruction to pay out coins equivalent to the amount of credits a player has earned (1 coin for 1 credit) to a coin tray 24 through a coin payout opening 23 or for inputting an instruction to pay out credits in a form of bar-code ticket 25 to be described later.

The 1-BET button 16 is operation means for accepting an instruction to wager 1 credit upon a game out of all the credits a player has held. The MAX-BET button 17 is operation means for accepting an instruction to wager maximum number of credits (5 credits is the maximum number in the first embodiment) a player can wager upon per one game out of all the credits the player has held.

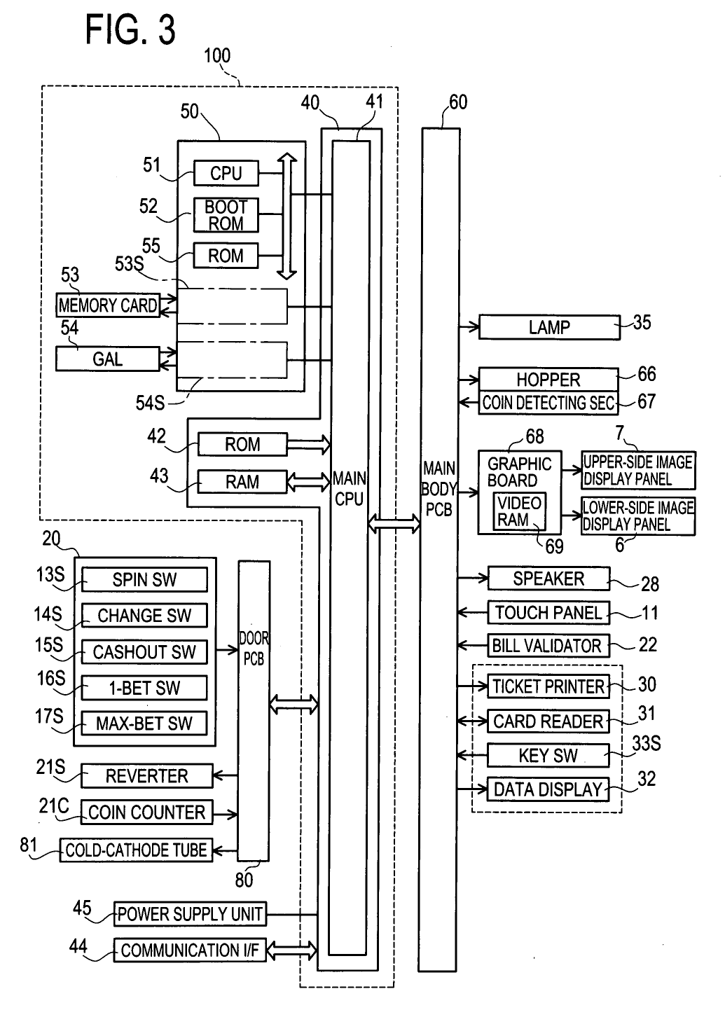

Inside of the coin insertion slot 21, a reverter 21S and a coin counter 21C (see FIG. 3 for both) are provided. The reverter 21S discriminates forgery of coins and expels improper coins from the coin payout opening 23. The coin counter 21C detects proper coins accepted by the coin counter 21C and counts the number of them.

The bill validator 22 discriminates counterfeit bills and accepts authentic bills into the cabinet 2. Bills inserted in the cabinet 2 are converted into the number of coins and credits equivalent to the converted number of coins are added to credits the player should hold. Incidentally, the bill validator 22 is able to read a bar-code ticket 25 to be described later. On a lower front face of the main door 4, i.e., a lower portion of the control panel 20, there is provided a glass panel 26 on which character(s) of the slot machine 1 or the like is depicted.

As to the slot machine 1 directed to the first embodiment, coins, bills, or electric valuable information (credit) corresponding to coins and bills are used as gaming media. However, in the present invention, types of gaming media are not restricted to the above. For example, medal, token, electric money, ticket, and the like are applicable as gaming media.

Below the upper-side image display panel 7, a ticket printer 30, a card reader 31, a data display 32 and a key pad 33 are provided.

The ticket printer 30 is a printing device for printing a bar-code on a ticket in which data of the amount of credits, a date, an identification number of the slot machine 1, and the like are encoded, and outputting such a ticket as bar-code ticket 25. A player gets other gaming machine read the outputted bar-code ticket 25 so as to play a game with the target gaming machine or to take certain procedures at a certain section in a game arcade (e.g., a cashier in a casino).

The card reader 31 is to read data from a smart card and, vice versa, to write data in a smart card. A smart card is a card a player should bring with him/her and, for example, data concerning game history of the player, and the like are recorded thereon.

The data display 32 is made of fluorescent display or the like and displays data read by the card reader 31 and data inputted by a player with the key pad 33, for example. The key pad 33 is used for inputting instructions and data concerning issuance of ticket and the like. Furthermore, a lamp 35 is provided on a top face of the top box 3. The lamp 35 is turned on and flashes in a predetermined manner so as to summon a shop keeper when an error occurs to the slot machine 1.

Incidentally, “28” is a speaker.

Next, there will be described symbols depicted on reel bands of respective reels and repositioned in symbol display regions of the symbol display frames 10A and 10B.

Twenty-two symbols are depicted on reel bands of respective reels. Each symbol column is made by combining “RED7”, “BLUE7”, “BELL”, “CHERRY”, “STRAWBERRY”, “PLUM”, “ORANGE”, and “APPLE”. The above mentioned symbols are positioned on reel bands of respective reels in individually different orders and combinations.

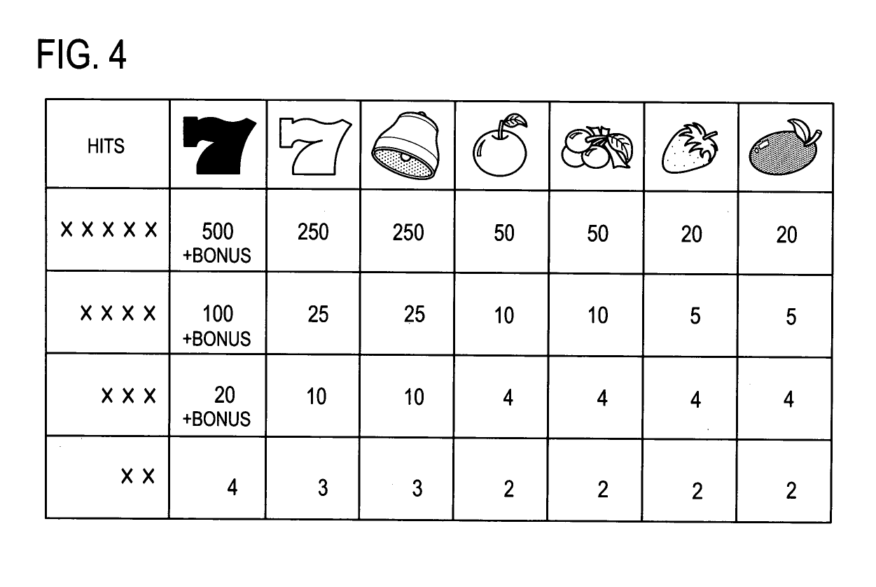

As to symbols “RED7”, “BLUE7”, “BELL”, “CHERRY”, “STRAWBERRY”, “PLUM”, and “APPLE”, when two, three, four, or five identical symbols out of the above are repositioned in succession from a left-most symbol display region or from a right-most symbol display region on an activated pay line L within the second symbol display frame 10B, predetermined amount of payout is awarded to a player (see FIG. 4).

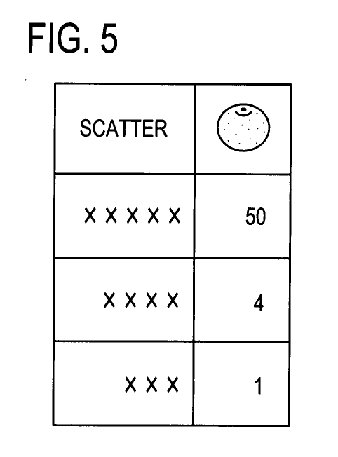

Furthermore, “ORANGE” is a scatter symbol of scatter-and-any combination payout. That is, predetermined amount of payout depending on the number of the scatter symbols is awarded to a player in case three, four, or five scatter symbols are repositioned within the second symbol display frame 10B regardless whether or not the scatter symbols are repositioned on a certain pay line L (see FIG. 5).

In case three, four, or five “RED7” symbols are repositioned on an activated pay line L within the second symbol display frame 10B in succession from a left-most symbol display region or from a right-most symbol display region, predetermined amount of payout is awarded to a player and a bonus game occurs. Games to be carried out by the slot machine 1 directed to the first embodiment consist of two game modes, namely, base game and bonus game. A base game is played in such a manner that a player aims to reposition a certain symbol combination on activated the pay line(s) 1L, 2L, 3L, 4L, and 5L within the second symbol display frame 10B and fifteen reels are used therein. In a base game, there is also carried out a game to win a scatter-and-any combination payout in which a player aims to reposition an “ORANGE” symbol, i.e., scatter symbol, within the second symbol display frame 10B. On the other hand, a bonus game is played in such a manner that three jewelry boxes as choices are indicated in the lower-side image display panel 6, and then, a game directed to player's choice of a jewelry box associated with payout amount is carried out. Details of the bonus game will be omitted here.

After the 1-BET button 16 or the MAX-BET button 17 is operated to designate the number of bets and the spin button 13 is pressed on, symbol columns depicted on reel bands of respective reels in scroll from top to bottom are displayed through respective symbol display regions of the second symbol display frame 10B (see FIG. 8). After a predetermined time lapses, respective reels stop spinning and a part of respective symbol columns of the reels is displayed through respective symbol display regions of the second symbol display frame 10B. That is, a single symbol is repositioned in each symbol display regions of the second symbol display frame 10B and fifteen symbols in total are repositioned there (see FIG. 9). Furthermore, various winning symbol combinations (see FIG. 4) are previously determined. In case a symbol combination on one of activated pay lines L1, L2, L3, L4, and L5 within the second symbol display frame 10B coincides with a certain winning symbol combination, payout of the winning symbol combination is awarded to a player.

Furthermore, payouts associated with the number of “ORANGE” symbols are previously defined (see FIG. 5) and in case “ORANGE” symbols are repositioned within the second symbol display frame 10B, a payout depending on the number of “ORANGE” symbols is awarded to a player.

Next, there will be described a control system of the slot machine 1 directed to the first embodiment by referring to FIG. 3. FIG. 3 is a block diagram showing a control system of the slot machine 1 schematically.

As shown in FIG. 3, the control system of the slot machine 1 basically consists of a mother board 40 and a gaming board 50.

The gaming board 50 comprises: a CPU 51, a ROM 55, a boot ROM 52, connected to one another by internal bus; a card slot 53S for accepting a memory card 53; and an IC socket 54S compatible with GAL (Generic Array Logic) 54.

The memory card 53 is a non-volatile memory which is a recording medium to store a game program and a game system program (termed as game program and the like, hereafter) therein. The game program stored in the memory card 53 includes a lottery program. The lottery program is to determine fifteen symbols to be repositioned in fifteen symbol display regions of the second symbol display frame 10B (i.e., determine code numbers corresponding to respective symbols to be repositioned). The lottery program also includes symbol weight data associated with plural kinds of payout rate (e.g., 80%, 84%, 88%). The symbol weight data is data to associate code numbers of respective symbols with one or plural random numbers belonging to a predetermined numerical value range (0˜255) with respect to each of the fifteen reels. That is, one or plural random numbers is/are associated with a code number of a symbol. A random number is extracted through a lottery, whereby a symbol specified with the extracted random number(s) is repositioned.

Payout rate is determined in accordance with payout rate setting data outputted from the GAL 54 and a lottery is carried out in accordance with the symbol weight data associated with the payout rate.

Furthermore, the lottery program includes a program to determine the number of symbols a player can drag, out of fifteen symbols repositioned in the first symbol display frame 10A.

The card slot 53S is structured such that a memory card 53 can be inserted in and pulled out from there, and connected to the mother board 40 with IDE bus. Therefore, kinds of games and rules to be executed with the slot machine 1 can be changed by rewriting and changing contents of a game program and the like stored in the memory card 53 to other ones. Kinds of games and rules to be executed with the slot machine 1 can be also changed by replacing a memory card 53 which stores a game program and the like with other memory card 53 which stores other game program and the like.

Game program includes: a program concerning game progress; image data and sound data to be outputted during a game; image data of symbols depicted on reel bands of the respective reels; image data concerning game rules, payout table, and the like; and demonstration image data.

The GAL 54 is a kind of PLD which has OR-fixed type array structure. The GAL 54 has plural input ports and output ports and when certain data is inputted to an input port, data associated with the inputted data is outputted from an output port. The data outputted from the output port is the afore-mentioned payout setting data.

The IC socket 54S is structured such that the GAL 54 can be attached to and detached from there, and connected to the mother board 40 with PCI bus. Therefore, payout rate setting data to be outputted from the GAL 54 can be changed by writing over program to be stored in the detached GAL 54 or changing a GAL 54 with other GAL 54.

The CPU 51, the ROM 55 and the boot ROM 52 connected to one another with internal bus are connected to the mother board 40 with PCI bus. The PCI bus transmits signals between the mother board 40 and the gaming board 50 and supplies power from the mother board 40 to the gaming board 50. The ROM 55 stores country identification information and an authentication program. The boot ROM 52 stores an auxiliary authentication program, a program (boot code) with which the CPU 51 can activate the auxiliary authentication program, and the like.

The authentication program is a program (falsification-check program) for authenticating a game program and the like. The authentication program is described along falsification-check procedure of the game program and the like which is subject to an authentication-fetch processing. The auxiliary authentication program is a program for authenticating the afore-mentioned authentication program and is described along falsification-check procedure of the authentication program which is subject to an authentication processing.

Next, there will be described the mother board 40. The mother board 40 is constituted by a commercially available and versatile mother board (printed-wiring board on which essential parts of a personal computer are mounted), and equipped with a main CPU 41, a ROM 42, and a RAM 43.

The ROM 42 consists of a memory device such as flash memory or the like, and stores programs such as BIOS to be executed by the main CPU 41, and permanent data such as lottery tables of base game and bonus game, payout tables (see FIG. 4 and FIG. 5), and the like. When the BIOS is executed by the main CPU 41, an initialization processing for certain peripheral devices is carried out and a fetch processing for fetching game program and the like is started through the gaming board 50.

The RAM 43 stores data and programs to be used when the main CPU 41 operates. The RAM 43 can store various programs to be read out through the gaming board 50, namely, the authentication program, the game program and the like, various information such as amount of credits a player currently holds, a variable N to be described later, and the like.

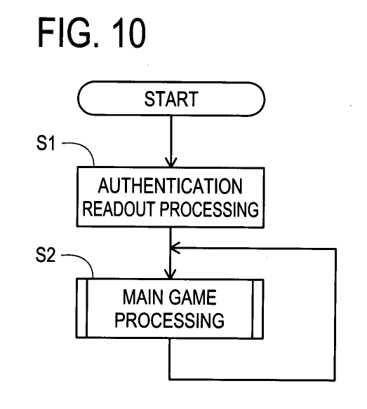

A communication interface 44 is connected to the mother board 40. The communication interface 44 is a communicating device for communicating with a server or the like installed in a game arcade through a communication line. The slot machine 1 communicates with a server or the like through the communication interface 44 to transmit bet information, a lottery result of a base-game lottery processing and the like which are dealt in a main game processing (see S2 in FIG. 10) to be described later.

A main body PCB 60 and a door PCB 80 both described later are separately connected to the mother board 40 with USB. Furthermore, a power supply unit 45 is connected to the mother board 40. When power is supplied to the mother board 40 from the power supply unit 45, the main CPU 41 in the mother board 40 is activated and at the same time, power is supplied to the gaming board 50 through PCI bus, whereby the CPU 51 is activated.

A game controller 100 is constituted by the mother board 40 and the gaming board 50.

On the other hand, devices for generating input signals to be inputted to the game controller 100 and devices of which operations are controlled by control signals outputted from the game controller 100 are connected to the main body PCB 60 and the door PCB 80. The game controller 100 executes the game program and the like stored in the RAM 43 in accordance with an input signal inputted to the game controller 100. Carrying out a certain processing operation, the game controller 100 stores a processing result in the RAM 43 and carries out control operation of various devices.

The lamp 35, the hopper 66, the coin detecting section 67, the graphic board 68, the speaker 28, the touch panel 11, the bill validator 22, the ticket printer 30, the card reader 31, the key switch 33S, and the data display 32 are connected to the main body PCB 60.

The touch panel 11 is provided on a front face of the lower-side image display panel 6. The touch panel 11 is capable of specifying a position in a coordinate touched by a player, and detecting a portion the player touched and which direction the touched portion has moved in accordance with the specified coordination position information. Thereby, the player can designate a symbol within the first symbol display frame 10A and a symbol display region within the second symbol display frame 10B.

The hopper 66 is provided inside of the cabinet 2 and pays out predetermined number of coins to the coin tray 24 through the coin payout opening 23 in accordance with a control signal outputted from the game controller 100. The coin detecting section 67 outputs an input signal to the game controller 100 when detecting payout of predetermined number of coins from the coin payout opening 23.

A graphic board 68 controls image display at the upper-side image display panel 7 and the lower-side image display panel 6 in accordance with a control signal outputted from the game controller 100. For example, amount of player's credits stored in the RAM 43 is displayed at the credit amount display section 8. Furthermore, amount of credits to be awarded as payouts is displayed at the payout amount display section 9.

The graphic board 68 is equipped with a VDP (Video Display Processor) for generating image data in accordance with control signals outputted from the game controller 100, a video RAM 69 for temporarily storing image data generated by the VDP, and the like. It is to be noted that image data used when generating image data with the VDP is included in the game program.

The graphic board 68 also controls motion image of the reels 5A, 5B, 5C, 5D, and 5E, namely, spinning and stopping of the reels 5A, 5B, 5C, 5D, and 5E, displayed in the lower-side image display panel 6 (see FIG. 1, FIG. 6 through FIG. 9) in accordance with control signals from the game controller 100.

Furthermore, the bill validator 22 discriminates forgery of a bill and a bar-code ticket 25 and accepts proper bill and bar-code ticket 25 into the cabinet 2. When accepting a proper bill, the bill validator 22 outputs an input signal to the game controller 100 based on value of the accepted bill. Furthermore, the bill validator 22 outputs an input signal to the game controller 100 based on the number of coins recorded in the proper bar-code ticket 25.

The ticket printer 30 prints a bar code in which data regarding amount of credits stored in the RAM 43 and the like are encoded in accordance with a control signals outputted from the game controller 100, and outputs the encoded data as bar-code ticket 25.

The card reader 31 reads data from a smart card to send it to the game controller 100 or writes data on a smart card in accordance with a control signal from the game controller 100. The key switch 33S is provided on the key pad 33 and outputs a certain input signal to the game controller 100 when the key pad 33 is operated by a player. The data display 32 displays data read out by the card reader 31 and data inputted by a player through the key pad 33 in accordance with a control signal outputted from the game controller 100.

A control panel 20, a reverter 21S, a coin counter 21C and a cold-cathode tube 81 are connected to the door PCB 80. The control panel 20 is equipped with a spin switch 13S directed to the spin button 13, a change switch 14S directed to the change button 14, a CASHOUT switch 15S directed to the CASHOUT button 15, a 1-BET switch 16S directed to the 1-BET button 16, and a MAX-BET switch 17S directed to the MAX-BET button 17. Each of the switches 13S through 17S outputs a signal to the game controller 100 when corresponding buttons are operated by a player.

The coin counter 21C is provided inside of the coin insertion slot 21 and discriminates forgery of a coin inserted in the coin insertion slot 21 by a player. Improper coins are ejected from the coin payout opening 23. The coin counter 21C outputs an input signal to the game controller 100 when detecting a proper coin.

The reverter 21S operates in accordance with a control signal outputted from the game controller 100 and divides and distributes coins discriminated as proper by the coin counter 21C to a cash box (not shown) or the hopper 66 both installed inside of the slot machine 1. The cold-cathode tube 81 works as back light arranged on rear-face sides of the lower-side image display panel 6 and the upper-side image display panel 7 and flashes in accordance with a control signal outputted from the game controller 100.

Next, by referring to FIG. 4 and FIG. 5, there will be described winning symbol combinations and payouts for them in case a base game is carried out with the slot machine 1 in which the reels within the second symbol display frame 10B are used. FIG. 4 is a first payout table showing winning symbol combinations and payouts for the respective winning symbol combinations in case a base game is carried out by using the reels within the second symbol display frame 10B.

It is to be noted that numerals indicated in the “PAYOUT” column shown in FIG. 4 are amount of payouts to be awarded per “1” bet. Therefore, in case the number of bets is “1”, payout value as shown in FIG. 4 is added to player's credits, and in case the number of bets is “2” or larger, a multiple of the number of bets on the payout value as shown in FIG. 4 is added to player's credits. Furthermore, in case plural winning symbol combinations are concurrently repositioned on plural activated pay lines L within the second symbol display frame 10B, payouts for the respective winning symbol combinations are totalized and awarded to a player.

For example, in case of winning a bonus game trigger, three, four, or five “RED7” symbols are repositioned on an activated pay line L in succession from a left-most symbol display region or from a right-most symbol display region within the second symbol display frame 10B, 20, 100, or 500 credits per 1-bet are awarded as payout and a bonus game occurs. In case two “RED7” symbols are repositioned on an activated pay line L in succession from a left-most symbol display region or from a right-most symbol display region within the second symbol display frame 10B, 4 credits per 1-bet are awarded as payout.

In case two, three, four, or five “BLUE7” symbols are repositioned on an activated pay line L in succession from a left-most symbol display region or from a right-most symbol display region within the second symbol display frame 10B, 3, 10, 25, or 250 credits per 1-bet are awarded as payout.

In case two, three, four, or five “BELL” symbols are repositioned on an activated pay line L in succession from a left-most symbol display region or from a right-most symbol display region within the second symbol display frame 10B, 3, 10, 25, or 250 credits per 1-bet are awarded as payout.

As to other winning symbol combinations listed therein, respective winning possibilities and amount of payouts per 1-bet have been set as shown in FIG. 4. However, in case a symbol combination repositioned on an activated pay line L does not coincide with any one of the winning symbol combinations shown in FIG. 4, it is a loss of a game and no credits are awarded (the cases as shown in FIG. 5 are excluded).

FIG. 5 is a second payout table showing winning symbol combinations and payouts for the respective winning symbol combinations in case of a base game is carried out by using the reels within the second symbol display frame 10B are used.

It is to be noted that numerals indicated in the “PAYOUT” column are amount of payouts to be awarded per “1” bet. Therefore, in case the number of bets is “1”, payout value as shown in FIG. 5 is added to player's credits, and in case the number of bets is “2” or larger, a multiple of the number of bets on the payout value as shown in FIG. 5 is added to player's credits.

According to the second payout table of FIG. 5, in case three, four, or five “ORANGE” symbols are repositioned within the second symbol display frame 10B regardless whether or not the scatter symbols are repositioned on an activated pay line L, 1, 4, or 50 credits per 1-bet are awarded as payout.

Next, there will be described main control program to be executed in the slot machine 1 of the first embodiment by referring to drawings. FIG. 10 is a flowchart of a main control program.

It is to be noted that, before the main control program is executed, the memory card 53 has been inserted in the card slot 53S of the gaming board 50 and the GAL 54 has been attached to the IC socket 54S.

When power is turned on at the power supply unit 45, the game controller 100 is activated and an authentication readout processing is carried out at S1. In the authentication readout processing, the mother board 40 and gaming board 50 both of which constitute the game controller 100 carry out their respective processing procedures separately and simultaneously.

That is, in the gaming board 50, the CPU 51 reads out the auxiliary authentication program stored in the boot ROM 52 and carries out auxiliary authentication in accordance with the auxiliary authentication program to verify and prove that no falsification of the program is found before fetching the program to the mother board 40.

On the other hand, in the mother board 40, the main CPU 41 executes the BIOS stored in the ROM 42, and gets compressed data included in the BIOS decompressed into the RAM 43, thereby to execute the BIOS decompressed into the RAM 43 and to carry out diagnosis and initialization of various peripheral devices.

After that, the game controller 100 reads out the authentication program stored in the ROM 55 and verifies and authenticates that the no falsification is found in the game program and the like stored in the memory card 53 inserted in the card slot 53S. After the authentication processing completes normally, the game controller 100 writes and stores the authenticated game program and the like in the RAM 43, and then, obtains payout rate setting data and country identification information.

After completion of the above procedures, the game controller 100 completes the authentication readout processing.

In S2, the game controller 100 sequentially reads out and executes the game program and the like authenticated at the authentication readout processing of S1 thereby to carry out a main game processing. By carrying out the main game processing, a game directed to the present embodiment is carried out with the slot machine 1. The main game processing is repeatedly carried out while power is supplied to the slot machine 1.

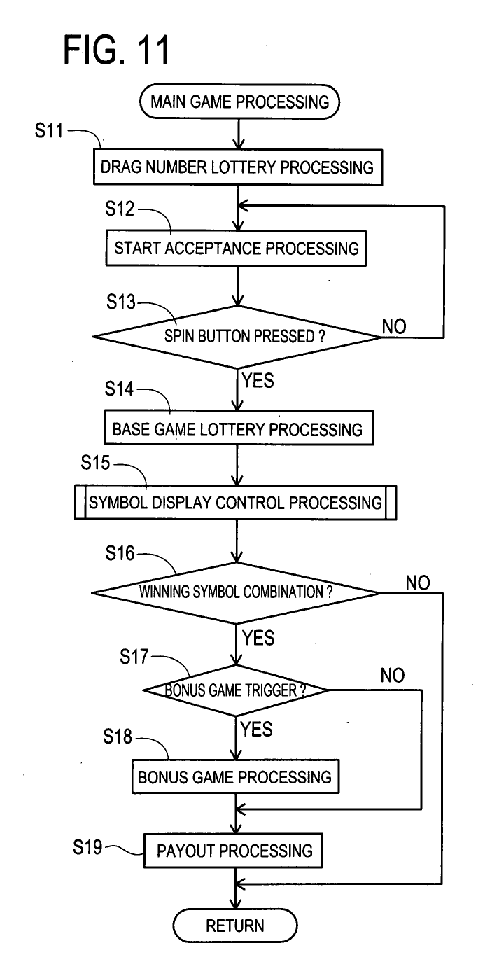

Next, there will be described a subroutine concerning the main game processing of S2 by referring to FIG. 11.

FIG. 11 shows the flowchart of the main game processing to be carried out in the slot machine 1 directed to the first embodiment. It is to be noted that programs indicated in the flowchart of FIG. 11 are stored in the ROM 42 or RAM 43 and executed by the game controller 100.

As shown in FIG. 11, after predetermined initial setting, the game controller 100 carries out a drag number lottery processing at S11. To be more specific, at the drag number lottery processing, the game controller 100 executes a random number generating program included in the lottery program stored in the RAM 43, whereby a random number value is selected from a numerical value range (0˜255). In accordance with the selected random number, the number of symbols (a numeral) a player can drag is determined and the determined number of symbols (a numeral) is substituted for a variable N at the RAM 43.

After that, the game controller 100 firstly carries out a start acceptance processing at S12 in which an inserted coin is accepted and the number of bets on the pay line L is set. At the start acceptance processing, insertion of a coin and bet operation with the 1-BET button 16 or the MAX-BET button 17 are done by a player.

In case of 1 bet, a pay line L1 is activated. In case of 2 bets, pay lines L1 and L2 are activated. In case of 3 bets, pay lines L1, L2, and L3 are activated. In case of 4 bets, pay lines L1, L2, L3, and L4 are activated. In case of 5 bets (maximum), pay lines L1, L2, L3, L4 and L5 are activated.

At this moment, as shown in FIG. 6, there is displayed the first symbol display frame 10A with fifteen symbols are repositioned.

Next, the controller 100 judges whether or not the spin button 13 has been pressed at S13. For judging presence or absence of an input from the spin button 13, the game controller 100 detects whether or not to receive an input signal outputted from the spin switch 13S.

In case the spin button 13 is not pressed (S13: NO), the processing returns to the start acceptance processing (S12) again. Under this state, a player can change the number of bets or the like by operating bet buttons. In case the spin button 13 is pressed on (S13: YES), the number of bets equal to the number of to-be-activated pay lines among L1, L2, L3, L4, and L5 set by operating the 1-BET button 16 and the MAX-bet button 17 is subtracted from amount of credits a player currently holds, and stored in the RAM 43 as bet information.

After entering into S14, the game controller 100 carries out a base game processing in which reels within the second symbol display frame 10B are used.

At S14, the game controller 100 carries out a base game lottery processing. To be more specific, the game controller 100 executes a random number generating program included in the lottery program stored in the RAM 43, whereby a random number value is selected for each of the fifteen symbol display regions within the second symbol display frame 10B from a numerical value range (0˜255). Next, the game controller 100 refers to symbol weight data associated with the payout rate setting data and determines code numbers in accordance with the selected fifteen random number values. After the determined code numbers of the respective symbol display regions within the second symbol display frame 10B are stored in the RAM 43, the processing goes on to S15.

The determined code numbers of the respective symbol display regions within the second symbol display frame 10B correspond to code numbers of symbols to be repositioned on respective pay lines L. Therefore, when the game controller 100 determines code numbers of the respective symbol display regions within the second symbol display frame 10B, a symbol combination in a target game is determined. Thus, by determining code numbers directed to the respective symbol display regions within the second symbol display frame 10B, a symbol combination lottery (see FIG. 4 and FIG. 5) is carried out.

At S15, the game controller 100 carries out a symbol display control processing.

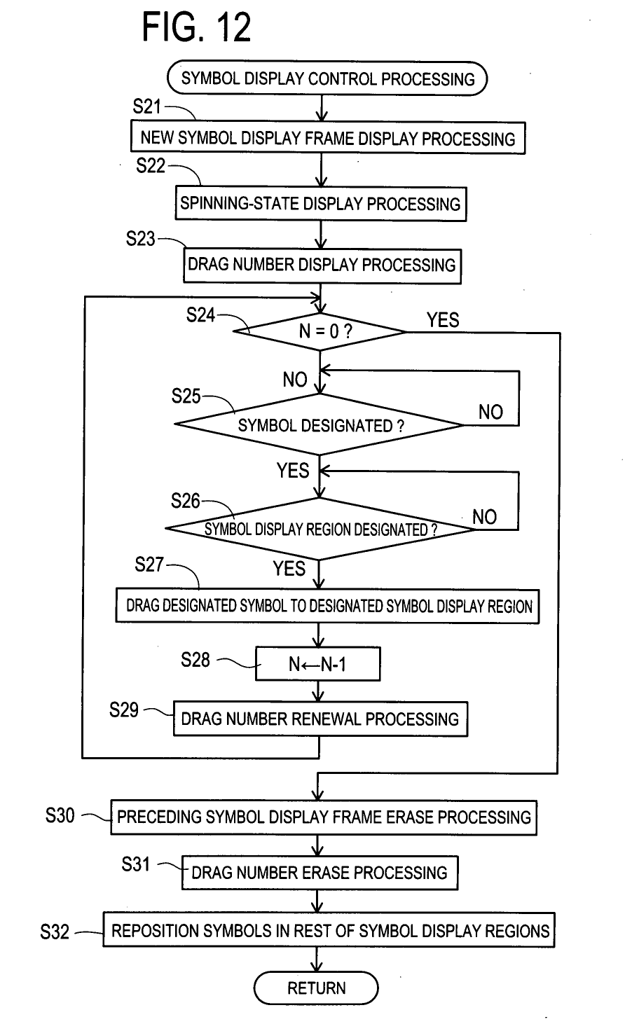

There will be described a subroutine concerning the symbol display control processing at S15 by referring to FIG. 12. FIG. 12 shows a flowchart of the symbol display control processing carried out in the slot machine 1 directed to the first embodiment. It is to be noted that programs executed in the flowchart of FIG. 12 are stored in the ROM 42 or the RAM 43 and executed by the game controller 100.

Firstly, as show in FIG. 12, the game controller 100 carries out a new symbol display frame display processing at S21. At this processing, the second symbol display frame 10B is displayed in the lower-side image display panel 6. To be more specific, as shown in FIG. 7, the second symbol display frame 10B is displayed together with the pay lines L1, L2, L3, L4, and L5 at the right side of the first symbol display frame 10A. It is to be noted this processing is carried out between the game controller 100 and the graphic board 68.

Next, the game controller carries out a spinning-state display processing at S22. At this processing, in the lower-side image display panel 6, there are displayed reels in scroll in respective symbol display regions within the second symbol display frame 10B (see FIG. 8). It is to be noted that this processing is carries out between the game controller 100 and the graphic board 68.

To be more specific, the game controller 100 sends the graphic board 68 a start signal to start spinning of the reels. Upon receiving the start signal, the graphic board 68 carries out a spinning-reel-image display processing. That is, the graphic board 68 carries out display control of the lower-side image display panel 6, whereby reels start spinning virtually in respective symbol display regions within the second symbol display frame 10B.

After sending the start signal, the game controller 100 determines effects to be carried out in a game (e.g., image to be displayed in the upper-side image display panel 7 and sound to be outputted from the speaker 28) and starts carrying out effects in accordance with the determined amusing manner.

At S23, the game controller 100 carries out a drag number display processing. At this processing, the drag number frame 5 is displayed in the lower-side image display panel 6 (see FIG. 8). Further on, the numeral (the number of symbols a player can drag) currently substituted for a variable N provided in the RAM 43 is displayed (see FIG. 8). It is to be noted this processing is carried out between the game controller 100 and the graphic board 68.

At S24, the game controller 100 judges whether or not the numeral (the number of symbols a player can drag) currently substituted for the variable N is “0”. In case the current variable, N is judged as not “0” (S24: NO), the processing goes on to S25.

At S25, the game controller 100 judges whether or not a player has touched and designated a symbol within the first symbol display frame 10A. This judgment is made in accordance with a location signal from the touch panel 11. In case it is judged that a player has not designated a symbol within the first symbol display frame 10A (S25: NO), the processing returns to S25 itself and stands-by until the player designates a symbol within the first symbol display frame 10A. In case it is judged that the player has designated a symbol within the first symbol display frame 10A (S25: YES), the processing goes on to S26. At this moment, the game controller 100 specifies a symbol within the first symbol display frame 10A touched and designated by the player in accordance with a location signal transmitted from the touch panel 11. This location signal is treated as information concerning the symbol within the first symbol display frame 10A touched and designated by the player and recorded in the RAM 43.

To be more specific, as shown at the upper stage of FIG. 1, in case the player touched a “BELL” symbol at a second row from top and a fourth column from left within the first symbol display frame 10A laid-out in the lower-side image display panel 6, information concerning the “BELL” symbol at the second row from top and the fourth column from left is recorded in the RAM 43.

At S26, the game controller 100 judges whether or not the player has touched and designated a symbol display region within the second symbol display frame 10B. This judgment is made in accordance with a location signal from the touch panel 11. In case it is judged that the player has not designated a symbol display region within the second symbol display frame 10B (S26: NO), the processing returns to S26 itself and stands-by until the player designates a symbol display region within the second symbol display frame 10B. In case it is judged that the player has designated a symbol display region within the second symbol display frame 10B (S26: YES), the processing goes on to S27. At this moment, the game controller 100 specifies a symbol display region within the second symbol display frame 10B touched and designated by the player is specified with a location signal transmitted from the touch panel 11. This location signal is treated as information concerning the symbol display region within the second symbol display frame 10B touched and designated by the player and recorded in the RAM 43.

To be more specific, as shown at the middle stage of FIG. 1, in case the player touched a symbol display region at a first row from top and a first column from left within the second symbol display frame 10B laid-out in the lower-side image display panel 6, information concerning the symbol display region at the first row from top and the first column from left is recorded in the RAM 43.

At S27, the game controller 100 drags the symbol within the first symbol display frame 10A touched and designated by the player to the symbol display region within the second symbol display frame 10B touched and designated by the player, whereby the designated symbol is repositioned and displayed in the designated symbol display region. At this moment, the symbol to be dragged is displayed in an outstanding manner within the first symbol display frame 10A. It is to be noted that this processing is carried out between the game controller 100 and the graphic board 68 in accordance with the information stored in the RAM 43 at S25 and S26.

To be more specific, in case the player designates the “BELL” symbol at the second row from top and the fourth column from left at S25 as shown at the upper stage of FIG. 1 and further designates the symbol display region at the first row from top and the first column from left at S26 as shown at the middle stage of FIG. 1, the “BELL” symbol is displayed in the symbol display region at the first row from top and first column from left instead of image of spinning reel as shown at the lower stage of FIG. 1. Thereby, it is regarded that the “BELL” symbol has been repositioned in the symbol display region at the first row from top and the first column from left within the second symbol display frame 10B. Furthermore, as shown at the lower stage of FIG. 1, the symbol display region at the second row from top and the fourth column from left within the first symbol display frame 10A is displayed in an outstanding manner so as to indicate the player that the symbol repositioned in the outstandingly-displayed symbol display region is the symbol to be dragged.

At S28, the game controller 100 subtracts “1” from the variable N provided in the RAM 43 and the processing goes on to S29.

At S29, a drag number renewal processing is carried out. At this processing, the numeral (the number of symbols a player can drag) currently substituted for a variable N provided in the RAM 43 is renewed and displayed in the drag number frame 5 within the lower-side image display panel 6. It is to be noted that this processing is carried out between the game controller 100 and the graphic board 68.

To be more specific, as shown at the middle and lower stages of FIG. 1, a number equal to the last displayed number from which “1” is subtracted is displayed in the drag number frame 5 within the lower-side image display panel 6.

After that, the processing returns to S24 and the so-far described series of processing is repeated. In case it is judged that a current variable N is “0” (S24: YES), the processing goes on to S30.

To be more specific, in case the number indicated in the drag number frame 5 within the lower-side image display panel 6 is “0” as shown at the upper stage of FIG. 9, it holds true of (S24: YES) Provided that it is determined that the number of symbols a player can drag should be “2” at S11, FIG. 9 sequentially illustrates such a state that two “BELL” symbols repositioned in the first symbol display frame 10A have been dragged to and repositioned in designated two symbol display regions within the second symbol display frame 10B.

At S30, the game controller 100 carries out a preceding symbol display frame erase processing. At this processing, the first symbol display frame 10A is erased out within the lower-side image display panel 6. To be more specific, the fist symbol display frame 10A and the belonging five pay lines L1, L2, L3, L4, and L5 are erased out together within the lower-side image display panel 6, as shown at the middle stage of FIG. 9. It is to be noted that this processing is carried out between the game controller 100 and the graphic board 68.

At S31, the game controller carries out a drag number erase processing. At this processing, the drag number frame 5 and “0”, the number indicated there, are erased out together within the lower-side image display panel 6 (see upper and middle stages of FIG. 9). It is to be noted that this processing is carried out between the game controller 100 and the graphic board 68.

At S32, the game controller 100 repositions a single symbol in each of the rest of symbol display regions within the second symbol display frame 10B other than symbol display region(s) designated for drag destination at S27.

This processing is to control to stop spinning of the reels so that symbols determined at the base game lottery processing (S14) should be repositioned in their respective symbol display regions. It is to be noted that this processing is carried out between the game controller 100 and the graphic board 68.

To be more specific, when comes a predetermined timing to stop spinning of the reels, the game controller 100 sends code numbers of the respective reels stored in the RAM 43 to the graphic board 68. The graphic board 68 carries out a stopped-reel-image display processing in accordance with the code numbers assigned to the respective reels. Thereby, symbols associated with a lottery result at S13 are repositioned in respective symbol display regions within the second symbol display frame 10B laid-out in the lower-side image display panel 6. However, out of all of the symbol display regions within the second symbol display frame 10B, a symbol display region designated for symbol drag destination has been fixed with a designated symbol dragged at S27. Therefore, such a symbol display region is excluded from the processing to be done at S32. Thus, a single symbol is repositioned in each of the symbol display regions within the second symbol display frame 10B laid-out in the lower-side image display panel 6. That is, fifteen symbols in total are repositioned (see lower stage of FIG. 9).

After that, the processing returns to the main game processing of FIG. 11.

Returning to the main game processing of FIG. 11, the game controller 100 judges whether or not a symbol combination coincides with a winning symbol combination at S16. This judgment is made in accordance with code numbers recorded in the RAM 43 at S14 and the first and second payout tables (see FIG. 4 and FIG. 5). In case it is judged as winning symbol combination (S16: YES) the processing goes on to S17. In case it is judged as not winning symbol combination (S16: NO), the main game processing is carried out again.

At S17, the game controller 100 judges whether or not a bonus game trigger is won in a base game. To be more specific, provided that the first payout table of FIG. 4 is used, in case a symbol combination of three, four or five “RED7” symbols are repositioned on an activated pay line L within the second symbol display frame 10B, it is judged as winning a bonus game trigger.

In case of a bonus game trigger (S17: YES), the game controller 100 carries out an optional type bonus game processing at S18. Details of the bonus game processing will be omitted here. After that, including “after the judgment of not a bonus game trigger” (S17: NO), the game controller 100 carries out a payout processing (S19). At the payout processing, total payouts won in a base game and a bonus game are awarded to a player.

At the payout processing, payout can be made with coins equivalent to amount of credits (1 credit per 1 coin) by pressing the CASHOUT button 15, or made with a bar-code ticket 25.

After the payout processing, the main game processing is carried out again.

It is to be noted that the present invention is not restricted to the above-described embodiment but, not to mention, it can be variously improved and changed within the scope not departing from the subject matter thereof.

For example, processing order of S25-S26 may be changed to S26-S25, i.e. the processing for a player to designate a symbol within the first symbol display frame 10A at S25 may come after the processing for a player to designate a symbol display region within the second symbol display frame 10B at S26.

Next, there will be described a second embodiment. An outline construction and a circuit structure of a slot machine directed to the second embodiment are similar to those of the slot machine 1 directed to the first embodiment and so are the flowcharts concerning operational control of it. Therefore, numerals same as those of the slot machine 1 directed to the first embodiment are assigned to similar structural portions and procedural steps of the slot machine directed to the second embodiment and description of them will be omitted. Only portions different from the slot machine 1 directed to the first embodiment will be described hereafter.

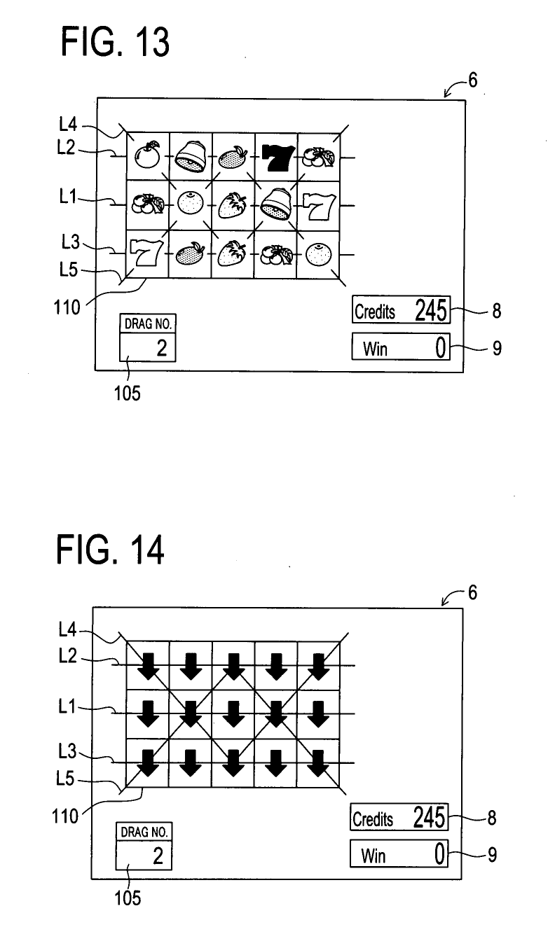

Here will be described game-related images displayed in a lower-side image display panel 6 of a slot machine 1 directed to the second embodiment. It is to be noted that the lower-side image display panel 6 is a video display. FIG. 13 and FIG. 14 are exemplary diagrams that may be displayed in the lower-side image display panel 6. As shown in FIG. 13 and FIG. 14, during a base game, the lower-side image display panel 6 displays a symbol display frame 110 in which fifteen symbols in total are positioned in a form of 3 rows×5 columns matrix. More specifically, in the symbol display frame 110, there are arranged fifteen symbol display regions in a form of 3 rows×5 columns matrix and in each of the fifteen symbol display regions, a single symbol out of plural symbols depicted on a single reel band is positioned. That is, a single symbol display region is assigned to each of the fifteen reels. In each of the symbol display regions, a single symbol out of plural symbols depicted on a reel band is positioned.

As shown in FIG. 14, in a base game, there are displayed reels spinning in their respective symbol display regions within the symbol display frame 110. As shown in FIG. 13, there are displayed reels stop spinning in their respective symbol display regions within the symbol display frame 110, whereby symbols depicted on respective reels are repositioned. FIG. 13 shows positioned or repositioned state of symbols depicted on reel bands of respective reels. FIG. 14 shows spinning state of the reel bands on which plural symbols are depicted.

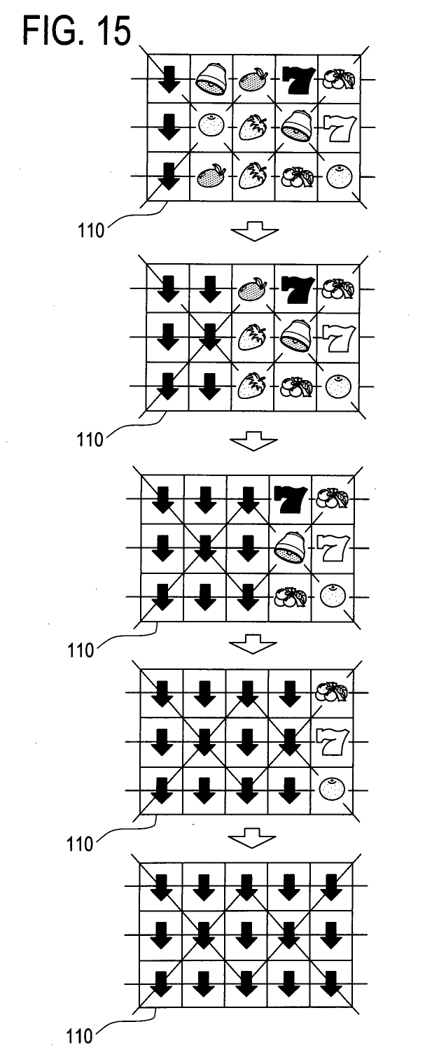

FIG. 15 illustrates state of reels sequentially displayed scrolling within the symbol display frame 110. That is, as shown in FIG. 15, in a base game, three reels directed to three symbol display regions positioned in a same column are displayed start scrolling concurrently, in order from the left column. Accordingly, as to fifteen symbols repositioned within the symbol display frame 110 in a preceding game, three symbols in a same column are concurrently displayed start scrolling in order from the left column when a next game is started. On that account, when the next game is started, a player cannot distinguish the fifteen symbols repositioned in the preceding game sequentially from three symbol display regions arranged in a left-most column.

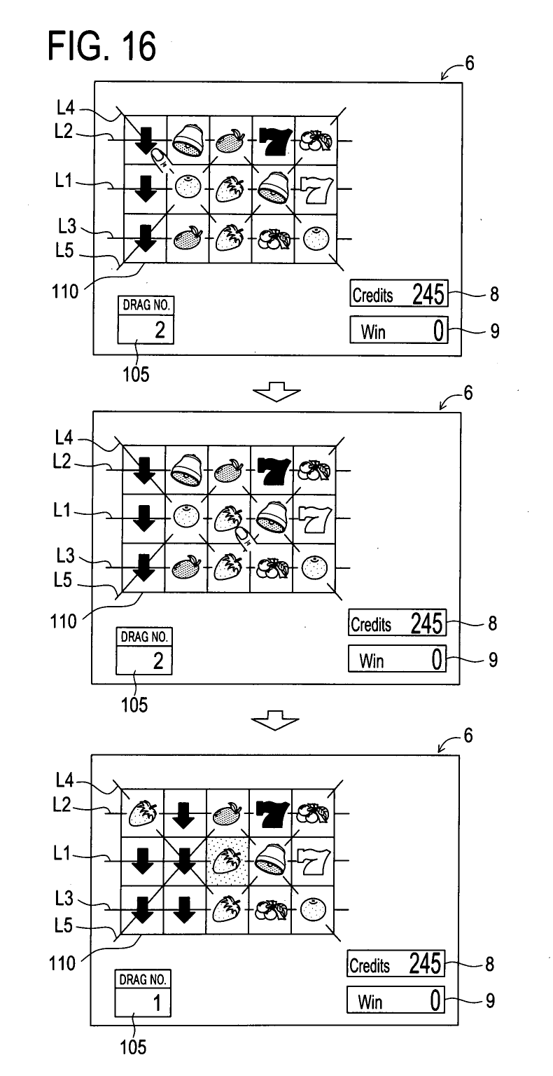

FIG. 16 is a diagram for illustrating a feature of typical game developments of the slot machine 1 directed to a second embodiment that may be encountered in accordance with the principles of the present invention. As shown in FIG. 16, as to the slot machine 1 directed to the second embodiment, in case a player carries out the following operation, a certain symbol positioned in the symbol display frame 110 in a preceding game can be repositioned in a certain symbol display region within the symbol display frame 110 by drag operation. For such operation, a player shall touch one of spinning-display-state symbol display regions within the symbol display frame 110 after reels in corresponding symbol display regions within the symbol display frame 110 start spinning virtually, as shown at an upper stage of FIG. 16. Further on, as shown at a middle stage of FIG. 16, the player shall touch one of stop-display-state symbol display regions in which symbols of the preceding game are still positioned. Consequently, as shown at a lower stage of FIG. 16, the symbol in the symbol display region the player firstly touched within the symbol display frame 110 is repositioned in the symbol display region the player secondly touched within the symbol display frame 110 by drag operation.

It is to be noted that symbol drag destination is restricted to one of spinning-display-state symbol display regions the player touched within the symbol display frame 110. Accordingly, a stop-display-state symbol display region within the symbol display frame 110 cannot be a symbol drag destination.

Furthermore, the number of symbols which a player can drag is restricted to a number indicated in a drag number frame 105 displayed in the lower-side image display panel 6. The number to drag is determined by a lottery which is carried out before the player operates a spin button.

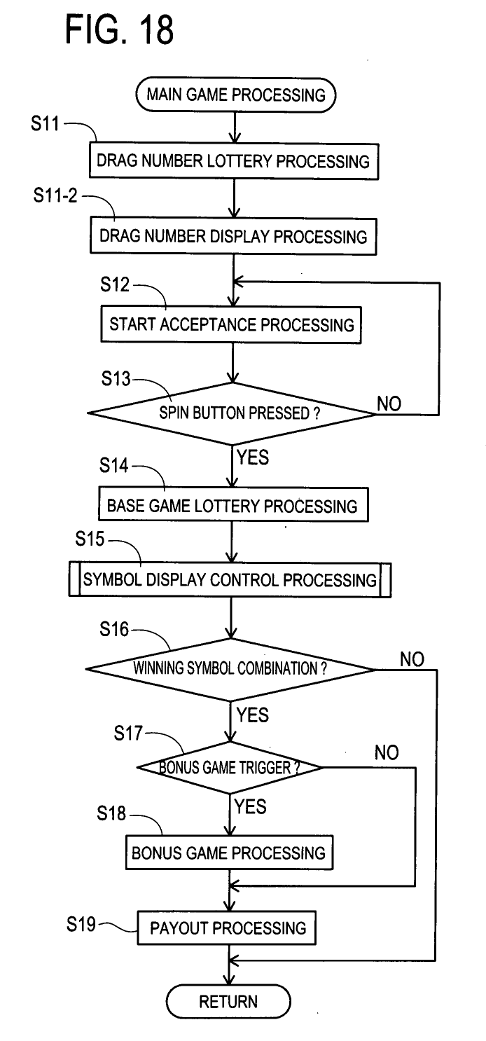

FIG. 18 shows the flowchart of a main game processing to be carried out in the slot machine 1 directed to the second embodiment. When the game controller 100 starts executing the main game processing program, the game controller 100 firstly carries out predetermined initial setting and then, further carries out a drag number lottery processing at S11 as shown in FIG. 18. The drag number lottery processing is carried out in a manner similar to S11 of the first embodiment (See FIG. 11).

At S11-2, the game controller carries out a drag number display processing. At this processing, the numeral (the number of symbols a player can drag) currently substituted for a variable N provided in the RAM 43 is displayed in the drag number frame 105 laid-out in the lower-side image display panel 6 (see FIG. 13). It is to be noted this processing is carried out between the game controller 100 and the graphic board 68.

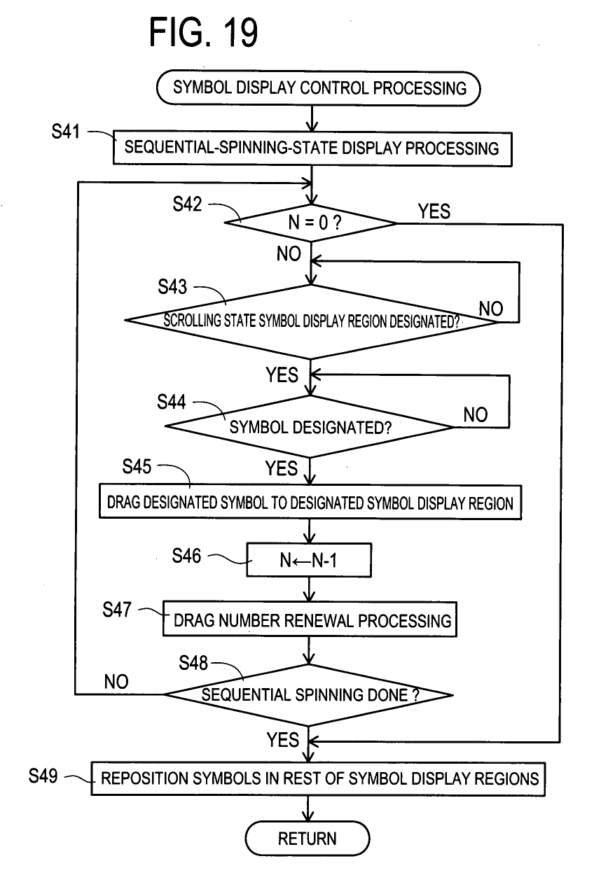

Except the symbol display control processing at S15, each processing to be carried out after S12 is carried out in a manner similar to each processing after S12 of FIG. 11 directed to the first embodiment. Therefore, here will be described the symbol display control processing at S15. FIG. 19 shows a flowchart of the symbol display control processing program to be executed in the slot machine 1 directed to the second embodiment.

Firstly, as shown in FIG. 19, the game controller 100 carries out a sequential-spinning-state display processing at S41. At this processing, there are displayed three reels directed to three symbol display regions positioned in a same column start spinning concurrently in order from a left column (see FIG. 14 and FIG. 15). It is to be noted that this processing is carried out between the game controller 100 and the graphic board 68.

To be more specific, the game controller 100 sends the graphic board 68 a start signal to start spinning of the reels. Upon receiving the start signal, the graphic board 68 carries out a spinning-reel-image display processing. That is, the graphic board 68 carries out display control of the lower-side image display panel 6, whereby reels start spinning virtually in respective symbol display regions within the symbol display frame 110 laid-out in the lower-side image display panel 6. Under this display control, spinning-state display is started and reels corresponding to three symbol display regions in a same column start spinning virtually in order from the left-most column within the symbol display frame 110 laid-out in the lower-side image display panel 6, as shown in FIG. 15.

After sending the start signal, the game controller 100 determines effects to be carried out in a game (e.g., image to be displayed in the upper-side image display panel 7 and sound to be outputted from the speaker 28) and starts carrying out effects in accordance with the determined amusing manner.

At S42, the game controller 100 judges whether or not the numeral (the number of symbols a player can drag) currently substituted for the variable N is “0”. In case the current variable N is judged as not “0” (S42: NO), the processing goes on to S43.

At S43, the game controller 100 judges whether or not a player has touched and designated a spinning-display state symbol display region within the symbol display frame 110. This judgment is made in accordance with a location signal from the touch panel 11. In case it is judged that a player has not designated a symbol display region within the symbol display frame 110 (S43: NO), the processing returns to S43 itself and stands-by until the player designates a spinning-display-state symbol region within the symbol display frame 110. In case it is judged that the player has designated a spinning-display-state symbol region within the symbol display frame 110 (S43: YES), the processing goes on to S44. At this moment, the game controller 100 specifies a symbol display region within the symbol display frame 110 touched and designated by the player in accordance with a location signal transmitted from the touch panel 11. This location signal is treated as information concerning the symbol display region within the symbol display frame 110 touched and designated by the player and recorded in the RAM 43.

To be more specific, as shown at the upper stage of FIG. 16, in case the player touched a symbol display region at a first row from top and a first column from left within the symbol display frame 110 laid-out in the lower-side image display panel 6, information concerning the symbol display region at the first row from top and the first column from left is recorded in the RAM 43.

At S44, the game controller 100 judges whether or not the player has touched and designated a symbol within the symbol display frame 110. This judgment is made in accordance with a location signal from the touch panel 11. In case it is judged that the player has not designated a symbol within the symbol display frame 110 (S44: NO), the processing returns to S44 itself and stands-by until the player designates a symbol within the symbol display frame 110. In case it is judged that a player has designated a symbol within the symbol display frame 110 (S44: YES), the processing goes on to S45. At this moment, the game controller 100 specifies a symbol within the symbol display frame 110 touched and designated by the player in accordance with a location signal transmitted from the touch panel 11. This location signal is treated as information concerning the symbol within the symbol display frame 110 touched and designated by the player and recorded in the RAM 43.

To be more specific, as shown at the middle stage of FIG. 16, in case the player touched a “STRAWBERRY” symbol at a second row from top and a third column from left within the symbol display frame 110 laid-out in the lower-side image display panel 6, information concerning the “STRAWBERRY” symbol at a second row from top and a third column from left is recorded in the RAM 43.

At S45, the game controller 100 drags the symbol within the symbol display frame 110 touched and designated by the player to the symbol display region within the symbol display frame 110 touched and designated by the player, whereby the designated symbol is repositioned and displayed in the designated symbol display region. At this moment, the symbol to be dragged is displayed in an outstanding manner within the symbol display frame 110. It is to be noted that this processing is carried out between the game controller 100 and the graphic board 68 in accordance with the information stored in the RAM 43 at S43 and S44.

To be more specific, in case the player designates the symbol display region at a first row from top and a first column from left at S 43 as shown at the upper stage of FIG. 16 and further designates the “STRAWBERRY” symbol at a second row from top and a third column from left at S44 as shown at the middle stage of FIG. 16, the “STRAWBERRY” symbol is displayed at the symbol display region at the first row from top and first column from left instead of image of spinning reel as shown at the lower stage of FIG. 16. Thereby, it is regarded that the “STRAWBERRY” symbol has been repositioned in the designated symbol display region at the first row from top and the first column from left within the symbol display frame 110. Furthermore, as shown at the lower stage of FIG. 16, the symbol display region at the second row from top and the third column from left within the symbol display frame 110 is displayed in an outstanding manner so as to indicate the player that the symbol repositioned in the outstandingly-displayed symbol display region is the symbol to be dragged.

At S46, the game controller 100 subtracts “1” from the variable N provided in the RAM 43 and the processing goes on to S47.

At S47, a drag number renewal processing is carried out. At this processing, the numeral (the number of symbols a player can drag) currently substituted for a variable N provided in the RAM 43 is renewed and displayed in the drag number frame 105 within the lower-side image display panel 6. It is to be noted that this processing is carried out between the game controller 100 and the graphic board 68.

To be more specific, as shown at the middle and lower stages of FIG. 16, a number equal to the last displayed number from which “1” is subtracted is displayed in the drag number frame 105 within the lower-side image display panel 6.

At S48, the game controller 100 judges whether or not spinning-state display of respective reels within the symbol display frame 110 laid-out in the lower-side image display panel 6 has been finished. To be more specific, in case there have been displayed three reels corresponding to three symbol display regions in a right-most column start spinning concurrently within the symbol display frame 110 laid-out in the lower-side image display panel 6, it is judged that spinning-state display has been finished with respect to all of the reels. It is to be noted that, this judgment is made when the game controller 100 sends the graphic board 68 a signal. In case it is judged that spinning-state display has been finished with respect to all of the reels (S48: YES), the processing goes on to S49 to be described later. In case it is judged that spinning-state display has not been finished (S48: NO), the processing returns to S42 and so-far described series of processing is repeated. Further on, in case it is judged that a current variable N is “0” (S42: YES), the processing goes on to S49.

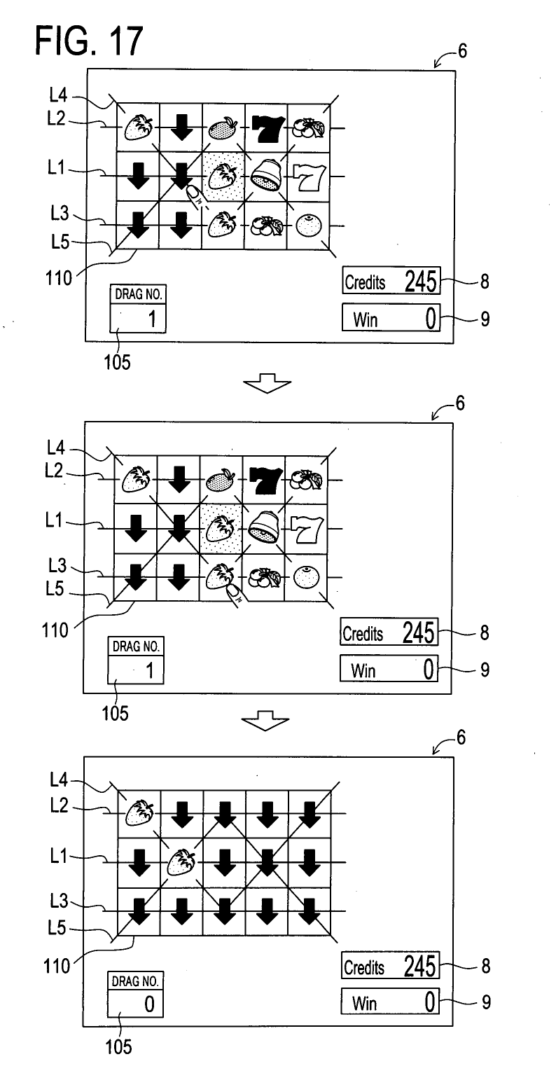

To be more specific, in case the number indicated in the drag number frame 105 within the lower-side image display panel 6 is “0” as shown at the lower stage of FIG. 17, it holds true of (S42: YES)

Provided that it is determined that the number of symbols a player can drag should be “2” at S11, the lower stage of FIG. 17 illustrates such a state that two “STRAWBERRY” symbols repositioned in the symbol display frame 110 in a preceding game have been repositioned in designated two symbol display regions within the symbol display frame 110 by drag operation (see FIG. 16 and FIG. 17).

At S49, the game controller 100 repositions a single symbol in each of the rest of symbol display regions within the symbol display frame 110 other than symbol display region(s) designated as drag destination at S45.

This processing is to control to stop spinning of the reels so that symbols determined at the base game lottery processing (S14) should be repositioned in their respective symbol display regions. It is to be noted that this processing is carried out between the game controller 100 and the graphic board 68.

To be more specific, when comes a predetermined timing to stop spinning of the reels, the game controller 100 sends code numbers of the respective reels to the graphic board 68. The graphic board 68 carries out a stopped-reel-image display processing in accordance with the code numbers assigned to the respective reels. Thereby, symbols associated with a lottery result at S14 are repositioned in respective symbol display regions within the symbol display frame 110 laid-out in the lower-side image display panel 6. However, out of all of the symbol display regions within the symbol display frame 110, the symbol display region(s) designated as drag destination has been fixed with a designated symbol dragged at S45. Therefore, such a symbol display region is excluded from the processing to be done at S49. Thus, a single symbol is repositioned in each of the symbol display regions within the symbol display frame 110 laid-out in the lower-side image display panel 6. That is, fifteen symbols in total are repositioned.

After that, the processing returns to the main game processing of FIG. 19.

It is to be noted that the present invention is not restricted to the above-described embodiment but, not to mention, it can be variously improved and changed within the scope not departing from the subject matter thereof.

For example, processing order of S43-S44 may be changed to S44-S43, i.e. the processing for a player to designate a symbol display region within the symbol display frame 110 at S43 may come after the processing for a player to designate a symbol within the symbol display frame 110 at S44.

Furthermore, regarding the sequential-spinning-state display processing, order of making symbols display regions start spinning may be different from the order illustrated in FIG. 15 or may be random.

Next, there will be described a third embodiment. An outline construction and a circuit structure of a slot machine directed to the third embodiment are similar to those of the slot machine 1 directed to the second embodiment and so are the flowcharts concerning operational control of it. Therefore, numerals same as those of the slot machine 1 directed to the second embodiment are assigned to similar structural portions and procedural steps of the slot machine directed to the third embodiment and description of them will be omitted. Only portions different from the slot machine 1 directed to the second embodiment will be described hereafter.

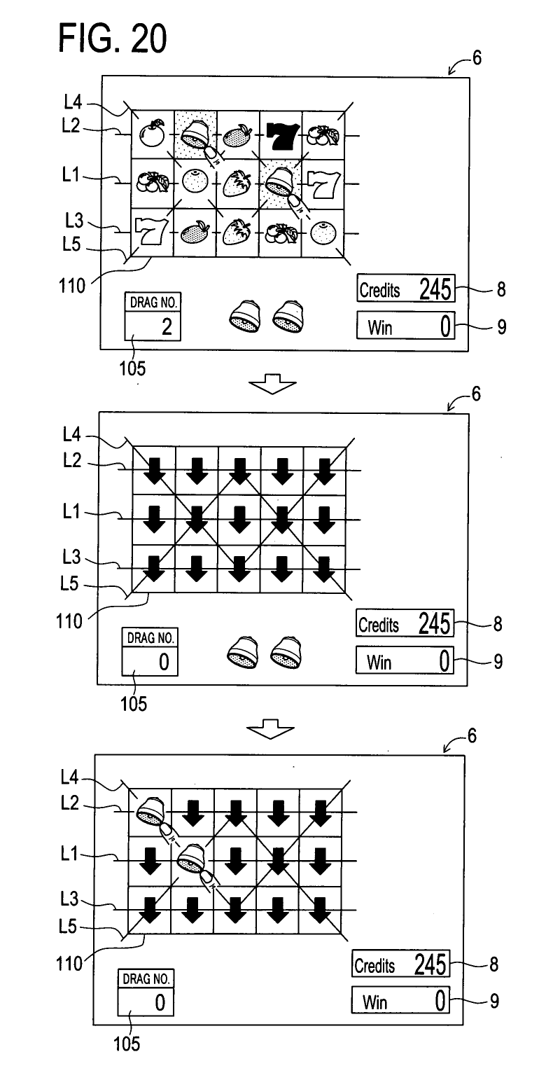

FIG. 20 is a diagram for illustrating a feature of typical game developments of the slot machine 1 directed to the third embodiment that may be encountered in accordance with the principles of the present invention. As shown in FIG. 20, as to the slot machine 1 directed to the third embodiment, in case a player carries out the following operation, a certain symbol positioned in the symbol display frame 110 in a preceding game can be repositioned in a certain symbol display region within the symbol display frame 110 by drag operation. For such operation, a player shall touch one of symbols repositioned respective symbol display regions within the symbol display frame 110 after symbols are repositioned within the symbol display frame 110, as shown at an upper stage of FIG. 20. As a result, the symbol the player touched is indicated at the outside of the symbol display frame 110 laid-out in the lower-side image display panel 6. After that, there are displayed all of the symbol display regions start spinning within the symbol display frame 110, as shown at the middle stage of FIG. 20. At this moment, the player shall touch one of the spinning-state symbol display regions, as shown at the lower stage of FIG. 20. Thereby, as shown at the lower stage of FIG. 20, the symbol indicated outside of the symbol display frame 110 is repositioned in the symbol display region the player touched within the symbol display frame 110 by drag operation.

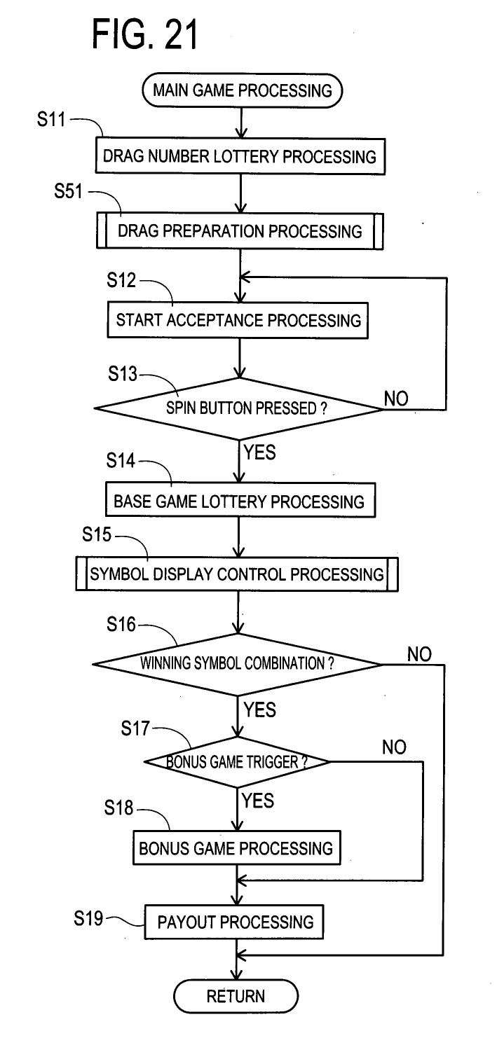

FIG. 21 shows the flowchart of a main game processing to be carried out in the slot machine 1 directed to the third embodiment. When the game controller 100 starts executing the main game processing program, the game controller 100 carries out predetermined initial setting and then, further carries out a drag number lottery processing at S11 as shown in FIG. 21. The drag number lottery processing is carried out in a manner similar to S11 of the first embodiment (See FIG. 11).

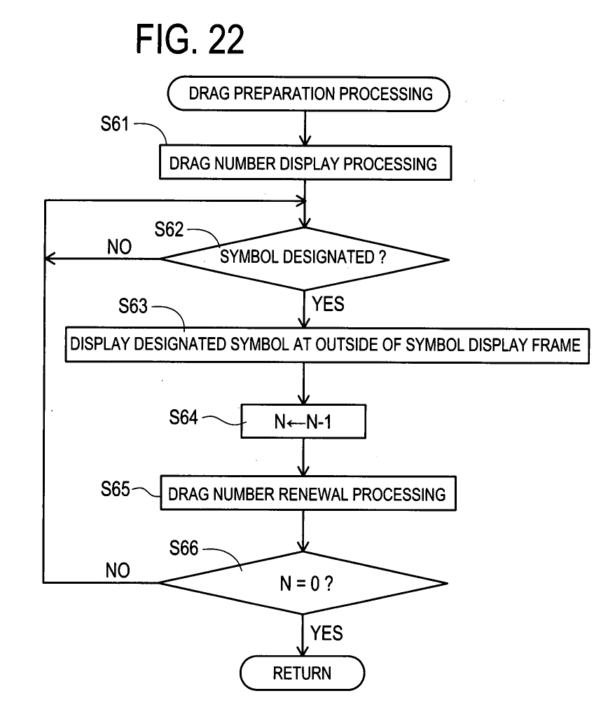

At S51, the game controller 100 carries out a drag preparation processing. By referring to FIG. 22, there will be described a sub routine of the drag preparation processing at S51. FIG. 22 is a flowchart of the drag preparation processing program to be executed by the slot machine 1 directed to the third embodiment. It is to be noted that programs indicated in the flowchart are stored in the ROM 42 or RAM 43 and executed by the game controller 100.

The game controller 100 firstly carries out a drag number display processing at S61 as shown in FIG. 22. This processing is carried out in a manner similar to S11-2 of the second embodiment (See FIG. 18).

At S62, the game controller 100 judges whether or not a player has touched and designated a symbol within the symbol display frame 110. This judgment is made in accordance with a location signal from the touch panel 11. In case it is judged that a player has not designated a symbol within the symbol display frame 110 (S62: NO), the processing returns to S62 itself and stands-by until the player designates a symbol within the symbol display frame 110. In case it is judged that the player has designated a symbol within the symbol display frame 110 (S62: YES), the processing goes on to S63. At this moment, the game controller 100 specifies a symbol within the symbol display frame 110 touched and designated by the player in accordance with a location signal transmitted from the touch panel 11. This location signal is treated as information concerning the symbol within the symbol display frame 110 touched and designated by the player and recorded in the RAM 43.

To be more specific, as shown at the upper stage of FIG. 20, in case the player touched a symbol at a first row from top and a second column from left within the symbol display frame 110 laid-out in the lower-side image display panel 6, information concerning the symbol at the first row from top and the second column from left is recorded in the RAM 43.

At S63, the game controller 100 displays the symbol within the symbol display frame 110 touched and designated by the player at the outside of the symbol display frame 110 laid-out in the lower-side image display panel 6. It is to be noted that this processing is carried out between the game controller 100 and the graphic board 68 in accordance with the information stored in the RAM 43 at S62.

To be more specific, in case the player designates a “BELL” symbol at a first row from top and a second column from left at S62 as shown at the upper stage of FIG. 20, the “BELL” symbol is indicated at the outside of the symbol display frame 110 laid-out in the lower-side image display panel 6. Furthermore, the symbol display region at the first row from top and the second column from left in which the “BELL” symbol is repositioned is displayed in an outstanding manner so as to indicate the player that the symbol repositioned in the outstandingly-displayed symbol display region is the symbol to be dragged.

At S64, the game controller 100 subtracts “1” from the variable N provided in the RAM 43 and the processing goes on to S65.

At S65, a drag number renewal processing is carried out. At this processing, the numeral (the number of symbols a player can drag) currently substituted for a variable N provided in the RAM 43 is newly displayed in the drag number frame 105 within the lower-side image display panel 6. It is to be noted that this processing is carried out between the game controller 100 and the graphic board 68.

At S66, the game controller 100 judges whether or not the numeral (the number of symbols a player can drag) currently substituted for the variable N is “0”. In case the current variable N is judged as “0” (S66: YES), the processing returns to the main game processing of FIG. 21. In case the current variable N is judged as not “0” (S66: NO), the processing returns to S62 and repeats the so-far described series of processing.

Provided that it is determined that the number of symbols a player can drag should be “2” at S11, the upper stage of FIG. 20 illustrates such a situation that a series of processing S62 through S66 has been repeated twice, two “BELL” symbols repositioned within the symbol display frame 110 have been touched and designated at two times of S62, and therefore, the two “BELL” symbols are indicated at the outside of the symbol display frame 110 (see FIG. 20). Since the series of processing S62 through S66 has been repeated twice, “0” is supposed to be indicated within the drag number frame 105 at the upper stage of FIG. 20. However for the sake of explanatory convenience, “2” is indicated there.

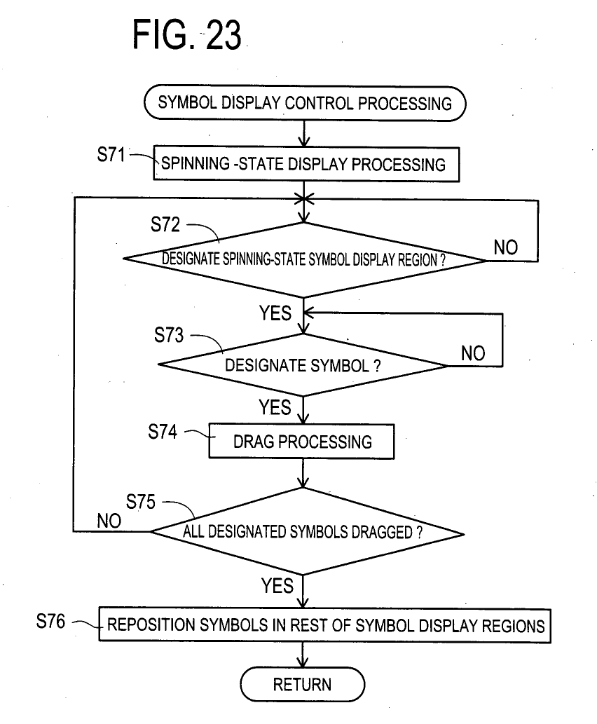

Back to the main game processing of FIG. 21, the game controller 100 carries out a start acceptance processing at S12. Except the symbol display control processing at S15, each processing to be carried out after S12 is actually carried out in a manner similar to each processing to be carried out after S12 directed to the first embodiment shown in FIG. 11. Therefore, there will only be described the symbol display control processing at S15. FIG. 23 is a flowchart of the symbol display control processing program to be executed by the slot machine directed to the third embodiment.

As shown in FIG. 23, the game controller 100 carries out a spinning-state display processing at S71. At this processing, there are displayed all of the symbol display regions start spinning concurrently within the symbol display frame 110 laid-out in the lower-side image display panel 6 (see middle stage of FIG. 20). It is to be noted that this processing is carried out between the game controller 100 and the graphic board 68.

To be more specific, the game controller 100 sends the graphic board 68 a start signal to start spinning of the reels. Upon receiving the start signal, the graphic board 68 carries out a spinning-reel-image display processing. That is, the graphic board 68 carries out display control of the lower-side image display panel 6, whereby reels start spinning virtually in respective symbol display regions within the symbol display frame 110 laid-out in the lower-side image display panel 6. Under this display control, there are displayed all of the symbol display regions start spinning concurrently within the symbol display frame 110 laid-out in the lower-side image display panel 6, as shown at the middle stage of FIG. 20.

After sending the start signal, the game controller 100 determines effects to be carried out in a game (e.g., image to be displayed in the upper-side image display panel 7 and sound to be outputted from the speaker 28) and starts carrying out effects in accordance with the determined amusing manner.

At S72, the game controller 100 judges whether or not a player has touched and designated one of the spinning-state symbol display regions within the symbol display frame 110. This judgment is made in accordance with a location signal from the touch panel 11. In case it is judged that a player has not designated a spinning-state symbol display region within the symbol display frame 110 (S72: NO), the processing returns to S72 itself and stands-by until the player designates a spinning-state symbol display region within the symbol display frame 110. In case it is judged that a player has designated a spinning-state symbol display region within the symbol display frame 110 (S72: YES), the processing goes on to S73. At this moment, the game controller 100 specifies the symbol within the symbol display frame 110 touched and designated by the player in accordance with a location signal transmitted from the touch panel 11. This location signal is treated as information concerning the symbol display region within the symbol display frame 110 touched and designated by the player and recorded in the RAM 43.

To be more specific, as shown at the lower stage of FIG. 20, in case the player touched a symbol display region at a first row from top and a first column from left within the symbol display frame 110 laid-out in the lower-side image display panel 6, information concerning the symbol display region at the first row from top and the first column from left is recorded in the RAM 43.

At S73, the game controller 100 judges whether or not the player has touched and designated a symbol indicated at the outside of the symbol display frame 110. This judgment is made in accordance with a location signal from the touch panel 11. In case it is judged that the player has not designated a symbol at the outside of the symbol display frame 110 (S73: NO), the processing returns to S73 itself and stands-by until the player designates a symbol at the outside of the symbol display frame 110. In case it is judged that a player has designated a symbol at the outside of the symbol display frame 110 (S73: YES), the processing goes on to S74. At this moment, the game controller 100 specifies a symbol at the outside of the symbol display frame 110 touched and designated by the player is specified in accordance with a location signal transmitted from the touch panel 11. This location signal is treated as information concerning the symbol at the outside of the symbol display frame 110 touched and designated by the player and recorded in the RAM 43.

At S74, the game controller 100 drags the symbol at the outside of the symbol display frame 110 touched and designated by the player at S73 to the symbol display region within the symbol display frame 110 touched and designated by the player at S72, whereby the designated symbol is repositioned and displayed in the designated symbol display region. It is to be noted that this processing is carried out between the game controller 100 and the graphic board 68 in accordance with the information stored in the RAM 43 at S72 and S73.

To be more specific, in case the player designates a spinning-state symbol display region at a first row from top and a first column from left at S 72 and further designates one of the two “BELL” symbols at S73, the “BELL” symbol is displayed at the symbol display region at the first row from top and first column from left instead of image of spinning reel, as shown at the lower stage of FIG. 20. Thereby, it is regarded that a “BELL” symbol has been repositioned in the designated symbol display region at the first row from top and the first column from left within the symbol display frame 110. It is to be noted that as soon as the symbol the player designated at S73 is repositioned in the designated symbol display region by drag operation, it is erased out from the lower-side image display panel 6. The fact that the symbol has been erased out from the lower-side image display panel 6 is stored in the RAM 43 as symbol-drag-related information.

At S75, it is judged whether or not all of the symbol(s) indicated at the outside of the symbol display frame 110 laid-out in the lower-side image display panel 6 has been repositioned in designated symbol display region(s) by drag operation. This judgment is made in accordance with information stored in the RAM 43 at S74. In case it is judged that all of the symbol(s) indicated at the outside of the symbol display frame 110 laid-out in the lower-side image display panel 6 has not yet been repositioned in designated symbol display region(s) (S75: NO), the processing returns to S72 and the so-far described series of processing is repeated.

Provided that symbols indicated at the outside of the symbol display frame 110 laid-out in the lower-side image display panel 6 are two “BELL” symbols, the lower stage of FIG. 20 illustrates such a state that the two “BELL” symbols have been repositioned and displayed in respective designated symbol display regions by repeating a series of processing S72 through S74 twice while spinning-state display is kept at rest of the non-designated symbol display regions.

In case it is judged that all of the symbol(s) indicated at the outside of the symbol display frame 110 laid-out in the lower-side image display panel 6 has been repositioned in designated symbol display region(s) by drag operation (S75: YES), the processing goes on to S76.

At S76, the game controller 100 repositions a single symbol in each of the rest of symbol display regions within the symbol display frame 110 other than symbol display region(s) designated as drag destination at S74.

This processing is to control to stop spinning of the reels so that symbols determined at the base game lottery processing (S14) should be repositioned in their respective symbol display regions. It is to be noted that this processing is carried out between the game controller 100 and the graphic board 68.

To be more specific, when comes a predetermined timing to stop spinning of the reels, the game controller 100 sends code numbers of the respective reels to the graphic board 68. The graphic board 68 carries out a stopped-reel-image display processing in accordance with the code numbers assigned to the respective reels. Thereby, symbols associated with a lottery result at S14 are repositioned in respective symbol display regions within the symbol display frame 110 laid-out in the lower-side image display panel 6. However, out of all of the symbol display regions within the symbol display frame 110, the symbol display region designated as symbol drag destination at S74 has been fixed with a designated symbol dragged at S74. Therefore the symbol display region is excluded from the processing to be done at S76. Thus, a single symbol is repositioned in each of the symbol display regions within the symbol display frame 110 laid-out in the lower-side image display panel 6. That is, fifteen symbols in total are repositioned.

After that, the processing returns to the main game processing of FIG. 21.

It is to be noted that the present invention is not restricted to the above-described embodiment but, not to mention, it can be variously improved and changed within the scope not departing from the subject matter thereof.

For example, processing order of S72-S73 may be changed to S73-S72, i.e. the processing for a player to designate a symbol display region within the symbol display frame 110 at S72 may come after the processing for a player to designate a symbol to be indicated at the outside of the symbol display frame 110 at S73.

Furthermore, a series of processing S72 through S74 may be carried in such a manner that a symbol indicated at the outside of the symbol display frame 110 laid-out in the lower-side image display panel 6 is visually dragged to a designated symbol display region within the symbol display frame 110 by a player's keep touching and dragging with the aid of the touch panel 11.

What is claimed is:

1. A slot machine comprising:
a symbol display frame for displaying plural symbols individually positioned;
a display for displaying the symbol display frame;
a touch panel for enabling a player to designate one of locations within the symbol display frame or one of plural symbols individually displayed within the symbol display frame; and
a game controller programmed to operate with the display
(a) to reposition plural symbols individually positioned within the symbol display frame and newly display plural symbols individually repositioned within the symbol display frame every game, and
(b) in case the player designated a symbol among plural symbols displayed within the symbol display frame in a preceding game with the touch panel when the game controller carries out the operation (a), to newly reposition and display a designated symbol within the symbol display frame during a current game in a manner that the player drags the designated symbol to a location the player designates with the touch panel within the symbol display frame during the current game.

2. A slot machine according to claim 1, wherein, for carrying out the operation (a), the game controller is programmed to restrict locations within the symbol display frame the player can designate with the touch panel during the current game to locations within the symbol display frame where repositioning of symbols are being carried out.

3. A slot machine according to claim 1, wherein, for carrying out the operation (a), the game controller is programmed to determine number of symbols the player can designate among plural symbols displayed within the symbol display frame in the preceding game with the touch panel, after end of the preceding game and no later than start of the current game.

4. A slot machine according to claim 1, wherein, for carrying out the operation (a), the game controller is programmed to display number of symbols the player can designate among plural symbols displayed within the symbol display frame in the preceding game with the touch panel, after end of the preceding game and no later than start of the current game.

5. A slot machine comprising:
a symbol display frame for displaying plural symbols individually positioned;
a display for displaying the symbol display frame;
a touch panel for enabling a player to designate one of locations within the symbol display frame or one of plural symbols individually displayed within the symbol display frame; and
a game controller programmed to operate with the display
(a) to reposition plural symbols individually positioned within the symbol display frame and newly display plural symbols individually repositioned within the symbol display frame every game, and
(b) when the game controller carries out the operation (a),
(1) to determine number of symbols the player can designate among plural symbols displayed within the symbol display frame in the preceding game with the touch panel, after end of the preceding game and no later than start of the current game,
(2) in case the player designated a symbol among plural symbols displayed within the symbol display frame in the preceding game with the touch panel within a number range determined by the operation (1), to newly reposition and display a designated symbol within the symbol display frame during the current game in a manner that the player drags the designated symbol to a location the player designates with the touch panel within the symbol display frame during the current game, and
(3) for carrying out the operation (2), to restrict locations within the symbol display frame the player can designate with the touch panel during the current game to locations within the symbol display frame where repositioning of symbols are being carried out.

6. A slot machine comprising:
a symbol display frame for displaying plural symbols individually positioned;
a display for displaying the symbol display frame;
a touch panel for enabling a player to designate one of locations within the symbol display frame or one of plural symbols individually displayed within the symbol display frame; and
a game controller programmed to operate with the display
(a) to reposition plural symbols individually positioned within the symbol display frame and newly display plural symbols individually repositioned within the symbol display frame every game, and
(b) when the game controller carries out the operation (a),
(1) to display number of symbols the player can designate among plural symbols repositioned within the symbol display frame in the preceding game with the touch panel, after end of the preceding game and no later than start of the current game,
(2) in case the player designated a symbol among plural symbols displayed within the symbol display frame in the preceding game with the touch panel within a number range displayed by the operation (1), to newly reposition and display a designated symbol within the symbol display frame during the current game in a manner that the player drags the designated symbol to a location the player designates with the touch panel within the symbol display frame during the current game, and
(3) for carrying out the operation (2), to restrict locations within the symbol display frame the player can designate with the touch panel during the current game to locations within the symbol display frame where repositioning of symbols are being carried out.

7. A slot machine comprising:
a symbol display frame for displaying plural symbols individually positioned;
a display for displaying the symbol display frame;
a touch panel for enabling a player to designate one of locations within the symbol display frame or one of plural symbols individually displayed within the symbol display frame; and
a game controller programmed to operate with the display
(a) to reposition plural symbols individually positioned within the symbol display frame and newly display plural symbols individually repositioned within the symbol display frame every game, and
(b) when the game controller carries out the operation (a),
(1) to determine and display, number of symbols the player can designate among plural symbols repositioned within the symbol display frame in the preceding game with the touch panel, after end of the preceding game and no later than start of the current game,
(2) in case the player designated a symbol among plural symbols displayed within the symbol display frame in the preceding game with the touch panel within a number range determined by the operation (1), to newly reposition and display a designated symbol within the symbol display frame during the current game in a manner that the player drags the designated symbol to a location the player designates with the touch panel within the symbol display frame during the current game, and
(3) for carrying out the operation (2), to restrict locations within the symbol display frame the player can designate with the touch panel during the current game to locations within the symbol display frame where repositioning of symbols are being carried out.

8. A slot machine comprising:
plural symbol display regions for individually displaying plural symbols positioned;
a symbol display frame constituted by arranging the plural symbol display regions in a matrix form;
a display for displaying the symbol display frame;
a touch panel for enabling a player to designate one of plural symbol display regions or one of the plural symbols individually displayed in the plural symbol display regions;
a spin button for enabling the player to give a chance to start a game; and
a game controller programmed to operate with the display
(a) to reposition plural symbols individually positioned in the plural symbol display regions and newly display plural symbols individually repositioned in the plural symbol display regions by scrolling the plural symbol display regions in response to a chance to start a game given by the player,
(b) when the game controller carries out the operation (a),
(1) to determine number of symbols the player can designate among plural symbols individually displayed in the plural symbol display regions, which results from scroll of the plural symbol display regions in the preceding game, with the touch panel, after end of the preceding game and no later than start of the current game starts,
(2) when the player presses the spin button to give a change to start the current game, to cause the display to display a new symbol display frame structurally same as the symbol display frame so as to use in the current game,
(3) to make plural symbol display regions of the new symbol display frame scroll for the current game,
(4) when the player designates one of plural symbols individually displayed in the plural display regions in the symbol display frame used in the preceding game with the touch panel and further designates one of plural symbol display regions in the new symbol display frame with the touch panel, to reposition a designated symbol in a designated symbol display region within a number range determined by the operation (1) in a manner that the player drags the designated symbol to the designated symbol display region with the touch panel during the current game, and
(5) for carrying out the operation (4), to restrict symbol display regions the player can designate with the touch panel within the new symbol display frame to symbol display regions where scrolling of symbols are being carried out for the current game.

9. A slot machine comprising:
plural symbol display regions for individually displaying plural symbols positioned;
a symbol display frame constituted by arranging the plural symbol display regions in a matrix form;
a display for displaying the symbol display frame;
a touch panel for enabling a player to designate one of plural symbol display regions or one of the plural symbols individually displayed in the plural symbol display regions;
a spin button for enabling the player to give a chance to start a game; and
a game controller programmed to operate with the display
(a) to reposition plural symbols individually positioned in the plural symbol display regions and newly display plural symbols individually repositioned in the plural symbol display regions by scrolling the plural symbol display regions in response to a chance to start a game given by the player,
(b) when the game controller carries out the operation (a),
(1) to display number of symbols the player can designate among plural symbols individually displayed in the plural symbol display regions, which results from scroll of the plural symbol display regions in the preceding game, with the touch panel, after end of the preceding game and no later than start of the current game starts,
(2) when the player presses the spin button to give a change to start the current game, to make the plural symbol display regions which individually display plural symbols of the preceding game start scrolling sequentially by taking time difference for the current game,
(3) when the player designates one of plural symbols individually displayed in the plural symbol display regions in the preceding game with the touch panel before start of scrolling symbols for the current game, to make a symbol display region directed to a designated symbol start scrolling,
(4) when the player designates one of the plural symbol display regions in the symbol display frame with the touch panel, to reposition and display a symbol designated by the operation (3) in the designated symbol display region by dragging within a number range displayed by the operation (1) during the current game, and
(5) for carrying out the operation (4), to restrict symbol display regions the player can designate with the touch panel to symbol display regions where scrolling of symbols are being carried out for the current game.

10. A slot machine comprising:
plural symbol display regions for individually displaying plural symbols positioned;
a symbol display frame constituted by arranging the plural symbol display regions in a matrix form;
a display for displaying the symbol display frame;
a touch panel for enabling a player to designate one of plural symbol display regions or one of the plural symbols individually displayed in the plural symbol display regions;
a spin button for enabling the player to give a chance to start a game; and
a game controller programmed to operate with the display
(a) to reposition plural symbols individually positioned in the plural symbol display regions and newly display plural symbols individually repositioned in the plural symbol display regions by scrolling the plural symbol display regions in response to a chance to start a game given by the player,
(b) when the game controller carries out the operation (a),
(1) to display number of symbols the player can designate among plural symbols individually displayed in the plural symbol display regions, which results from scroll of the plural symbol display regions in the preceding game, with the touch panel, after end of the preceding game and no later than start of the current game starts,
(2) when the player presses the spin button to give a change to start the current game after the player has designated one of plural symbols individually displayed in the plural symbol display regions in the preceding game with touch panel, to make the plural symbol display regions which individually displayed plural symbols of the preceding game start scrolling for the current game,
(3) when the player designates one of the plural symbol display regions in the symbol display frame with the touch panel, to reposition and display a symbol designated by the operation (2) in the designated symbol display region by dragging within a number range displayed by the operation (1) during the current game, and
(4) for carrying out the operation (3), to restrict symbol display regions the player can designate with the touch panel to symbol display regions where scrolling of symbols are being carried out for the current game.

11. A playing method of a slot machine in which game controller repeats a game by using a display which displays a symbol display frame in which plural symbols are positioned, the playing method comprising:
a step of causing the display to reposition and newly display plural symbols individually within the symbol display frame every game with the game controller, the step comprising the sub-steps of
(1) making a player designate one of plural symbols displayed within the symbol display frame in a preceding game with a touch panel,
(2) making the player designate one of plural locations within the symbol display frame in a current game with the touch panel, and
(3) causing the display to newly reposition and display a symbol designated at the sub-step (1) in a location within the symbol display frame designated at the sub-step (2) by dragging during the current game with the game controller.

12. A playing method of a slot machine according to claim 11, wherein the step further comprises a sub-step of restricting locations within the symbol display frame the player can designate with the touch panel during the current game to locations within the symbol display frame where repositioning of symbols are being carried out with the game controller.

13. A playing method of a slot machine according to claim 11, wherein the step further comprises a sub-step of determining number of symbols the player can designate among plural symbols displayed within the symbol display frame in the preceding game with the touch panel, after end of the preceding game and no later than start of the current game.

14. A playing method of a slot machine according to claim 11, wherein the step further comprises a sub-step of causing the display to display number of symbols the player can designate among plural symbols displayed within the symbol display frame in the preceding game with the touch panel, after end of the preceding game and no later than start of the current game.

15. A playing method of a slot machine in which game controller repeats a game by using a display which displays a symbol display frame in which plural symbols are positioned, the playing method comprising:
a step of causing the display to reposition and newly display plural symbols individually within the symbol display frame every game with the game controller, the step comprising the sub-steps of,
(1) determining number of symbols the player can designate among plural symbols displayed within the symbol display frame in a preceding game with the touch panel, after end of the preceding game and no later than start of a current game,
(2) making the player designate a symbol among plural symbols displayed within the symbol display frame in the preceding game with the touch panel within a number range determined at the sub-step (1),
(3) restricting locations within the symbol display frame the player can designate with the touch panel during the current game to locations within the symbol display frame where repositioning of symbols are being carried out with the game controller,
(4) making the player designate a location among can-be-designated locations restricted at the sub-step (3) within the symbol display frame with the touch panel, and
(5) repositioning a symbol designated at the sub-step (2) to a location within the symbol display frame designated at the sub-step (4) by dragging during the current game.

16. A playing method of a slot machine in which game controller repeats a game by using a display which displays a symbol display frame in which plural symbols are positioned, the playing method comprising:
a step of causing the display to reposition and newly display plural symbols individually within the symbol display frame every game with the game controller, the step comprising the sub-steps of,
(1) displaying number of symbols the player can designate among plural symbols displayed within the symbol display frame in a preceding game with the touch panel, after end of the preceding game and no later than start of a current game,
(2) making the player designate a symbol among plural symbols displayed within the symbol display frame in the preceding game with the touch panel within a number range displayed at the sub-step (1),
(3) restricting locations within the symbol display frame the player can designate with the touch panel during the current game to locations within the symbol display frame where repositioning of symbols are being carried out with the game controller,
(4) making the player designate a location among can-be-designated locations restricted at the sub-step (3) within the symbol display frame with the touch panel, and
(5) repositioning a symbol designated at the sub-step (2) to a location within the symbol display frame designated at the sub-step (4) by dragging during the current game.

17. A playing method of a slot machine in which game controller repeats a game by using a display which displays a symbol display frame in which plural symbols are positioned, the playing method comprising:
a step of causing the display to reposition and newly display plural symbols individually within the symbol display frame every game with the game controller, the step comprising the sub-steps of,
(1) determining with the game controller and causing the display to display number of symbols the player can designate among plural symbols displayed within the symbol display frame in a preceding game with the touch panel, after end of the preceding game and no later than start of a current game,
(2) making the player designate a symbol among plural symbols displayed within the symbol display frame in the preceding game with the touch panel within a number range determined at the sub-step (1),
(3) restricting locations within the symbol display frame the player can designate with the touch panel during the current game to locations within the symbol display frame where repositioning of symbols are being carried out with the game controller,
(4) making the player designate a location among can-be-designated locations restricted at the sub-step (3) within the symbol display frame with the touch panel, and
(5) repositioning a symbol designated at the sub-step (2) to a location
within the symbol display frame designated at the sub-step (4) by dragging during the current game.

18. A playing method of a slot machine in which game controller repeats a game by using a display which displays a symbol display frame consisting of plural symbol display regions for individually displaying plural symbols arranged in a matrix form, the playing method comprising:
a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of,
(1) determining number of symbols the player can designate among plural symbols individually displayed in the plural symbol display regions, which results from scroll of the plural symbol display regions in a preceding game, with the touch panel, after end of the preceding game and no later than start of a current game starts,
(2) making a player give a chance to start a game with the spin button,
(3) causing the display to display a new symbol display frame structurally same as the symbol display frame so as to use in the current game in the display with the game controller,
(4) making plural symbol display regions of the new symbol display frame scroll for the current game with the game controller,
(5) making the player designate one of plural symbols individually displayed in the plural symbol display regions within the symbol display frame used in the preceding game with the touch panel,
(6) restricting symbol display regions the player can designate with the touch panel within the new symbol display frame to symbol display regions where scrolling of symbols are being carried out for the current game with the game controller,
(7) making the player designate a symbol display region among can-be-designated symbol display regions restricted at the sub-step (6) within the new symbol display frame with the touch panel, and
(8) repositioning a symbol designated at the sub-step (5) in a symbol display region designated at the sub-step (7) by dragging within a number range determined at the sub-step (1) with the game controller.

19. A playing method of a slot machine in which game controller repeats a game by using a display which displays a symbol display frame consisting of plural symbol display regions for individually displaying plural symbols arranged in a matrix form, the playing method comprising:
a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of,
(1) causing the display to display number of symbols the player can designate among plural symbols individually displayed in the plural symbol display regions, which results from scroll of the plural symbol display regions in a preceding game, with the touch panel, after end of the preceding game and no later than start of a current game starts with the game controller,
(2) making a player give a chance to start a game with the spin button,
(3) making the plural symbol display regions which individually display plural symbols of the preceding game start scrolling sequentially by taking time difference for the current game with the game controller,
(4) making the player designate one of plural symbols individually displayed in the plural symbol display regions with game controller, which results from scroll of the plural symbol display regions in the preceding game, before scrolling of symbols is started for the current game,
(5) making at least one symbol display region including a symbol display region directed to a symbol designated at the sub-step (4) start scrolling for the current game with the game controller,
(6) restricting symbol display regions the player can designate with the touch panel to symbol display regions where scrolling symbols are being carried out for the current game with the game controller,
(7) making the player designate a symbol display region among can-be-designated symbol display regions restricted at the sub-step (6) with the touch panel, and
(8) repositioning a symbol designated at the sub-step (4) in a symbol display region designated at the sub-step (7) by dragging within a number range determined at the sub-step (1) with the game controller.

20. A playing method of a slot machine in which game controller repeats a game by using a display which displays a symbol display frame consisting of plural symbol display regions for individually displaying plural symbols arranged in a matrix form, the playing method comprising:
a step of causing the display to reposition plural symbols individually positioned within the plural symbol display regions and newly display plural symbols individually repositioned within the plural symbol display regions with the game controller by scrolling the plural symbol display regions every game in response to a chance to start a game given by the player, the step comprising the sub-steps of,
(1) causing the display to display number of symbols the player can designate among plural symbols individually displayed in the plural symbol display regions, which results from scroll of the plural symbol display regions in a preceding game, with the touch panel, after end of the preceding game and no later than start of a current game starts with the game controller,
(2) making the player designate one of plural symbols individually displayed in the plural symbol display regions with game controller, which results from scroll of the plural symbol display regions in the preceding game, before scrolling of symbols is started for the current game,
(3) making a player give a chance to start a game with the spin button,
(4) making the plural symbol display regions which individually display plural symbols of the preceding game start scrolling for the current game with the game controller,
(5) restricting symbol display regions the player can designate with the touch panel to symbol display regions where scrolling symbols are being carried out for the current game with the game controller,
(6) making the player designate a symbol display region among can-be-designated symbol display regions restricted at the sub-step (5) with the touch panel,
(7) repositioning a symbol designated at the sub-step (2) in a symbol display region designated at the sub-step (6) by dragging within a number range determined at the sub-step (1) with the game controller.
